(19) United States
(12) Patent Application Publication
(10) Pub. No.: US 2026/0045274 A1
(43) Pub. Date: Feb. 12, 2026

(54) MAGNETIC RECORDING MEDIUM AND CARTRIDGE

(71) Applicant: Sony Group Corporation, Tokyo (JP)

(72) Inventors: Junichi TACHIBANA, Tokyo (JP); Hiroyuki KOBAYASHI, Tokyo (JP); Satoshi KODAMA, Tokyo (JP); Hiroyuki MURAKAMI, Tokyo (JP); Teruo SAI, Tokyo (JP); Sogo OIKAWA, Tokyo (JP)

(21) Appl. No.: 18/847,920

(22) PCT Filed: Jan. 10, 2023
(86) PCT No.: PCT/JP2023/000310

§ 371 Date: Mar. 25, 2025

(30) Foreign Application Priority Data
Mar. 30, 2022 (JP) 2022-057594

(51) Int. Cl. G11B 5/78

(52) U.S. Cl. CPC G11B 5/78

(57) ABSTRACT

Provided is a magnetic recording medium that is capable of increasing the reproduction output.

A magnetic recording medium is a tape-shaped magnetic recording medium and includes a recording layer. A nucleation magnetic field Hn of the magnetic recording medium satisfies a relationship of Hn≥0 [Oe], and the magnetic recording medium satisfies a relationship of the following formula (1).

$${( Mrt )}^{0.5} \times f ( Hs ) \geq 0.7 \qquad ( 1 )$$

(wherein, in the formula (1), Mrt represents a product of a residual magnetization amount Mr of the magnetic recording medium and a thickness t of the recording layer. Hs represents a saturation magnetic field of the magnetic recording medium. In a case where Hs≤8500 [Oe], f(Hs)=1.00, and in a case where Hs>8500 [Oe], f(Hs)=1/(1+(Hs−8500)/8500).).

### TECHNICAL FIELD

The present disclosure relates to a magnetic recording medium and a cartridge including the same.

### BACKGROUND ART

As the capacity of tape-shaped magnetic recording media increases, it is desired to further improve the SNR (Signal-Noise Ratio) of magnetic tapes in order to achieve high recording capacity. In order to improve the SNR, it is important to increase the reproduction output and reduce noise. For example, Patent Literature 1 discloses a technology for reducing noise in magnetic recording media and achieving a high S/N ratio by adjusting the composition of the magnetic film.

### CITATION LIST

### Patent Literature

Patent Literature 1: Japanese Patent Application Laid-open No. 2002-342908

### DISCLOSURE OF INVENTION

### Technical Problem

In recent years, developments in the field of reproduction output have focused on increasing the sensitivity of reproduction heads, and media have been required to have mainly lower noise. However, the technology for increasing the reproduction output is still important also on the media side.

An object of the present disclosure is to provide a magnetic recording medium that is capable of increasing the reproduction output and a cartridge including the same.

### Solution to Problem

In order to achieve the above-mentioned object, a magnetic recording medium according to the present disclosure is
a tape-shaped magnetic recording medium, including:
a recording layer,
a nucleation magnetic field Hn of the magnetic recording medium satisfying a relationship of Hn≥0 [Oe],
the magnetic recording medium satisfying a relationship of the following formula (1).

$${( Mrt )}^{0.5} \times f ( Hs ) \geq 0.7 \qquad ( 1 )$$

(wherein, in the formula (1), Mrt represents a product of a residual magnetization amount Mr of the magnetic recording medium and a thickness t of the recording layer. Hs represents a saturation magnetic field of the magnetic recording medium. In a case where Hs≤8500 [Oe], f(Hs)=1.00, and in a case where Hs>8500 [Oe], f(Hs)=1/(1+(Hs−8500)/8500).) A magnetic recording medium according to the present disclosure is
a tape-shaped magnetic recording medium, including:
a recording layer,
a nucleation magnetic field Hn of the magnetic recording medium satisfying a relationship of Hn≥0 [Oe],
the magnetic recording medium satisfying a relationship of the following formula (1).

$${( Mrt )}^{0.5} \times f ( Hs ) \geq 0.7 \qquad ( 1 )$$

(wherein, in the formula (1), Mrt represents a product of a residual magnetization amount Mr of the magnetic recording medium and a thickness t of the recording layer. Hs represents a saturation magnetic field of the magnetic recording medium. In a case where Hs≤4300 Bs [Oe], f(Hs)=1.00, and in a case where Hs>4300 Bs [Oe], f(Hs)=1/(1+(Hs−4300 Bs)/4300 Bs). Bs represents a saturation magnetic flux density of a core of a recording head used for recording on the magnetic recording medium, and a unit of Bs is tesla (T).)

### BRIEF DESCRIPTION OF DRAWINGS

FIG. 1 is a cross-sectional view showing an example of a configuration of a magnetic tape according to a first embodiment.

Part A of FIG. 2 is a schematic diagram showing a recording magnetic field generated in a recording head. Part B of FIG. 2 is a cross-sectional view taken along the line IIB-IIB in Part A of FIG. 2.

FIG. 3 is a diagram showing an example of an M-H loop of the magnetic tape in a perpendicular direction.

FIG. 4 is a diagram showing an example of a change in magnetization when a head magnetic field is reversed.

FIG. 5 Part A of FIG. 5 is a diagram describing an example of a state of recording magnetization before the head magnetic field is reversed (time T=T₀). Part B of FIG. 5 is a diagram describing an example of a state of recording magnetization after the head magnetic field is reversed (time T=T₀+ΔT). Part C of FIG. 5 is a diagram describing an example of a state of recording magnetization after the head magnetic field is reversed (time T=T₀+2ΔT).

FIG. 6 is a schematic diagram showing an example of a configuration of a sputtering apparatus to be used for producing the magnetic tape according to the first embodiment.

FIG. 7 is a cross-sectional view showing an example of a configuration of a magnetic tape according to a second embodiment.

FIG. 8 is a cross-sectional view showing an example of a configuration of a magnetic tape according to a third embodiment.

FIG. 9 is a cross-sectional view showing an example of a configuration of a cartridge according to a fourth embodiment.

FIG. 10 is a block diagram showing an example of a configuration of a cartridge memory.

FIG. 11 is a cross-sectional view showing an example of a configuration of a cartridge according to a fifth embodiment.

FIG. 12 is a graph showing a relationship between a parameter (Mrt)^{0.5}×f(Hs) and an amplitude of a reproduction signal.

### MODE(S) FOR CARRYING OUT THE INVENTION

Embodiments of the present disclosure will be described in the following order with reference to the drawings. Note that in all the drawings of the following embodiments, the same or corresponding portions will be denoted by the same reference symbols.
1 First embodiment (example of magnetic tape)
2 Second embodiment (example of magnetic tape)
3 Third embodiment (example of magnetic tape)
4 Fourth embodiment (example of cartridge)
5 Fifth embodiment (example of cartridge)

### 1 First Embodiment

### [Configuration of Magnetic Tape]

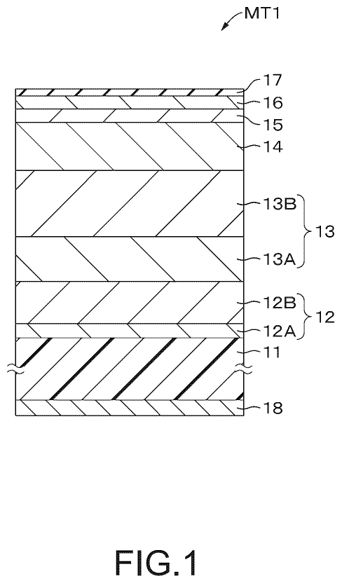

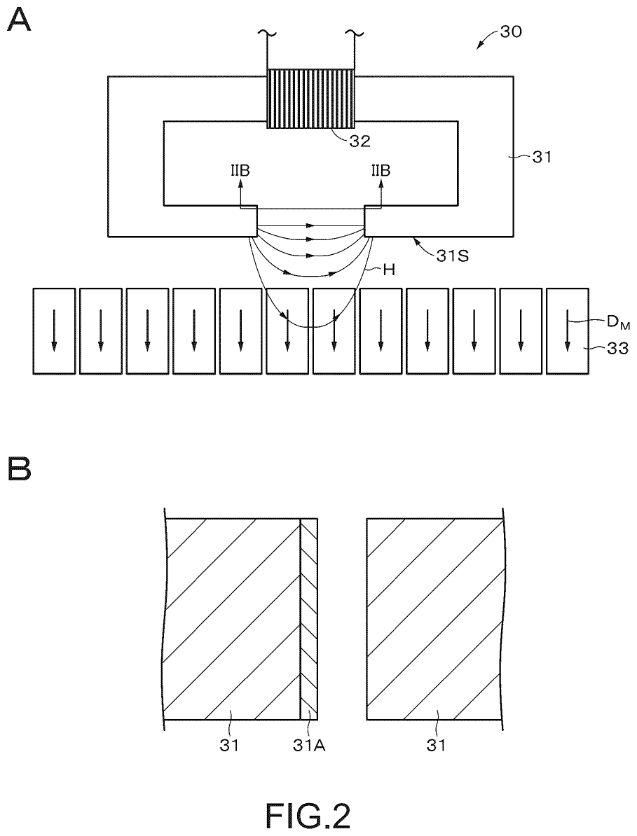

FIG. 1 is a cross-sectional view showing an example of a configuration of a magnetic tape MT1 according to a first embodiment. The magnetic tape MT1 according to the first embodiment is a tape-shaped perpendicular magnetic recording medium and includes a base 11, a seed layer 12, an underlayer 13, a recording layer 14, a CAP layer 15, a protective layer 16, a lubricant layer 17, and a back layer 18.

Note that although an example in which the magnetic tape MT1 includes the seed layer 12, the underlayer 13, the CAP layer 15, the protective layer 16, the lubricant layer 17, and the back layer 18 will be described in the first embodiment, the magnetic tape MT1 does not necessarily need to include at least one layer selected from these layers.

The seed layer 12, the underlayer 13, the recording layer 14, the CAP layer 15, the protective layer 16, and the lubricant layer 17 are provided in this order on a first main surface of the base 11. The back layer 18 is provided on a second main surface of the base 11.

The seed layer 12, the underlayer 13, the recording layer 14, the CAP layer 15, and the protective layer 16 may each be a vacuum thin-film such as a layer formed by sputtering (hereinafter, referred to also as a “sputtered layer”). The magnetic tape MT1 has a long shape and is caused to travel in the longitudinal direction during recording and reproduction.

The magnetic tape MT1 is suitable for use as a storage medium for data archives whose demand is expected to further grow in the future. This magnetic tape MT1 is capable of realizing, for example, areal recording density of 10 times or more that of current coating type magnetic tapes for storage, i.e., areal recording density of 100 Gb/in² or more. In the case where such a magnetic tape MT1 having areal recording density is used to form a general data cartridge of a linear recording system, it is possible to achieve large-capacity recording of 200 TB or more per data cartridge.

The magnetic tape MT1 is suitable for use in a recording/reproduction apparatus (recording/reproduction apparatus for recording and reproducing data) that includes a ring-type recording head and a tunneling magnetoresistive (TMR) or giant magnetoresistive (GMR) reproduction head. That is, the magnetic tape MT1 may be a magnetic tape for a recording/reproduction apparatus that includes a ring-type recording head and a TMR or GMR reproduction head. The magnetic tape MT1 is favorably one for which a ring-type recording head is used as a servo signal writing head. The recording layer 14 may be configured such that perpendicular recording of a data signal can be performed by, for example, a ring-type recording head. Further, the recording layer 14 may be configured such that perpendicular recording of a servo signal can be performed by, for example, a ring-type recording head. That is, the magnetic tape MT1 may be a magnetic tape that includes the recording layer 14 configured such that perpendicular recording of a data signal and a servo signal can be performed by a ring-type recording head.

An average thickness t_{T} of the magnetic tape MT1 is favorably 5.6 μm or less, more favorably 5.5 μm or less, and still more favorably 5.3 μm or less, 5.2 μm or less, 5.0 μm or less, or 4.6 μm or less. When the magnetic tape MT1 is thin like this, for example, it is possible to make the length of a tape wound into one magnetic recording cartridge longer and thus increase the recording capacity per magnetic recording cartridge. The average thickness t_{T} of the magnetic tape MT1 may be, for example, 3.0 μm or more, 3.2 μm or more, 3.4 μm or more, or 3.5 μm or more.

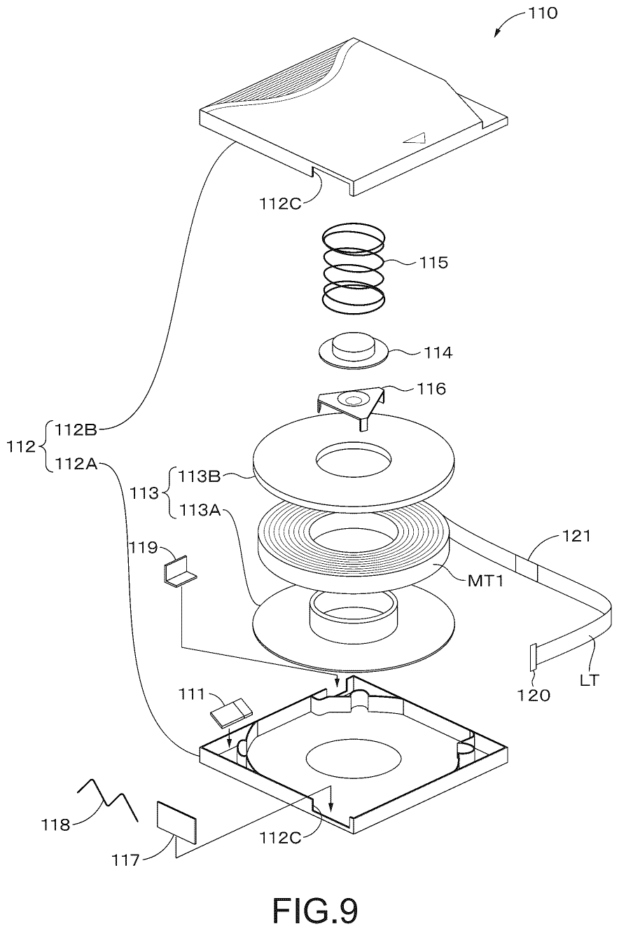

The average thickness t_{T} of the magnetic tape MT1 is obtained as follows. First, the magnetic tape MT1 is unwound from a reel or the like, and cut into a length of 250 mm at three positions 10 m to 20 m, 30 m to 40 m, and 50 m to 60 m from one end on the outermost periphery side to prepare three samples. Note that in the case where the leader tape LT is connected to the one end on the outermost periphery side of the magnetic tape MT1 (see FIG. 9), the three samples are cut at three positions 10 m to 20 m, 30 m to 40 m, and 50 m to 60 m from a connection part 121 between the magnetic tape MT and the leader tape LT. Also in the method of preparing a sample described below, in the case where the leader tape LT is connected to the one end on the outermost periphery side of the magnetic tape MT1, the samples are cut at predetermined positions with reference to the position of the connection part 121.

Next, for each sample, the thickness of the sample is measured at five positions using a Laser Hologage (LGH-110C) manufactured by Mitutoyo Corporation, and the (total of 15) measured values are simply averaged (arithmetically averaged) to calculate the average thickness t_{T} [μm]. Note that the measurement positions are randomly selected from the sample.

The width of the magnetic tape MT1 is, for example, 5 mm or more and 30 mm or less, particularly 7 mm or more and 25 mm or less, more particularly 10 mm or more and 20 mm or less, and still more particularly 11 mm or more and 19 mm or less.

The length of the magnetic tape MT1 may be, for example, 500 m or more and 1500 m or less, and may be, for example, 1000 m or more. For example, the width of the tape according to the LTO8 standard is 12.65 mm and the length of the tape is 960 m.

### (Base)

The base 11 is a long non-magnetic support having flexibility, and mainly has a function as a layer that is a base of the magnetic tape MT1. The base 11 is referred to as a base film layer in some cases, and may have a function as a film layer that imparts appropriate rigidity to the entire magnetic tape MT1.

The average thickness of the base 11 is, favorably 5.0 μm or less, less than 5.0 μm, 4.8 μm or less, less than 4.8 μm, 4.5 μm or less, less than 4.5 μm, more favorably 4.2 μm or less, still more favorably 3.6 μm or less, and still more favorably 3.3 μm or less. When the average thickness of the base 11 is within the above numerical range (e.g., 5.0 μm or less), it is possible to increase the recording capacity of one data cartridge to be more than that of a general magnetic tape. Note that the lower limit value of the average thickness of the base 11 may be determined from the viewpoint of the film deposition limit or the function of the base 11 and may be, for example, 2 μm or more, particularly 2.5 μm or more.

The average thickness of the base 11 can be obtained as follows. First, the magnetic tape MT1 is unwound from a reel or the like, and cut into a length of 250 mm at three positions 10 m to 20 m, 30 m to 40 m, and 50 m to 60 m from one end on the outermost periphery side to prepare samples. Subsequently, the layers other than the base 11 of each sample are removed with a solvent such as MEK (methyl ethyl ketone) and dilute hydrochloric acid. Next, the thickness of each sample (base 11) is measured at five positions using a Laser Hologage manufactured by Mitutoyo Corporation as a measuring apparatus, and the (total of 15) measured values are simply averaged (arithmetically averaged) to calculate the average thickness of the base 11. Note that the measurement positions are randomly selected from the sample.

The base 11 includes at least one selected from the group consisting of polyesters, polyolefins, a cellulose derivative, a vinyl resin, and a different polymer resin. In the case where the base 11 includes two or more of the above materials, the two or more materials may be mixed, copolymerized, or stacked. The polyesters include, for example, at least one selected from the group consisting of PET (polyethylene terephthalate), PEN (polyethylene naphthalate), PBT (polybutylene terephthalate), PBN (polybutylene naphthalate), PCT (polycyclohexylene dimethylene terephthalate), PEB (polyethylene-p-oxybenzoate), and polyethylene bisphenoxycarboxylate. The polyolefins include, for example, at least one selected from the group consisting of PE (polyethylene) and PP (polypropylene). The cellulose derivative includes, for example, at least one selected from the group consisting of cellulose diacetate, cellulose triacetate, CAB (cellulose acetate butyrate), and CAP (cellulose acetate propionate). The vinyl resin includes, for example, at least one selected from the group consisting of PVC (polyvinyl chloride) and PVDC (polyvinylidene chloride). The different polymer resin includes, for example, at least one selected from the group consisting of PA (polyamide, nylon), aromatic PA (aromatic polyamide, aramid), PI (polyimide), aromatic PI (aromatic polyimide), PAI (polyamideimide), aromatic PAI (aromatic polyamideimide), PBO (polybenzoxazole, e.g., Zylon (registered trademark)), polyether, PEK (polyetherketone), PEEK (polyetheretherketone), polyetherester, PES (polyethersulfone), PEI (polyetherimide), PSF (polysulfone), PPS (polyphenylene sulfide), PC (polycarbonate), PAR (polyarylate), and PU (polyurethane).

### (Seed Layer)

The seed layer 12 is provided between the base 11 and the underlayer 13. The seed layer 12 may have a two-layer structure. That is, the seed layer 12 may include a first seed layer 12A and a second seed layer 12B in this order on the first main surface of the base 11.

It is favorable to provide the seed layer 12 in the case where an intermediate layer 41 described below is formed thin or from the viewpoint of ensuring a favorable SNR even in the case of a layer configuration in which the intermediate layer 41 is not provided. The seed layer 12 may have a function of causing the underlayer 13 and the upper layers thereof, i.e., the underlayer 13, the recording layer 14, and the like to come close contact with the base 11.

The first seed layer 12A favorably has an amorphous state. The first seed layer 12A may favorably contain three atoms, Ti, Cr, and O, and have a composition with an average atomic ratio represented by, for example, the following formula (2A). The first seed layer 12A may be formed of, particularly, (TiCr)₉₈O₂.

$${( TiCr )}_{( 100 - x )} {O}_{x} \qquad ( 2 A )$$

(wherein, in the formula (2A), x satisfies, for example, the following relationship: 1≤x≤10, favorably 1≤x≤5, more favorably 1≤x≤3, and still more favorably x=2.)

In the case where x is too large (e.g., exceeds 10) in the above formula (2A), TiO₂ crystals are generated in the first seed layer 12A and the function as an amorphous layer is significantly reduced, which is not favorable.

The Ti metal alone has a hexagonal close-packed (hcp) structure in the crystal structure, similarly to a Co alloy. When the seed layer 12 (particularly, the first seed layer 12A) contains Ti, matching of the crystal structure between the recording layer 14 having a hexagonal close-packed (hcp) structure and the seed layer 12 is improved.

When the seed layer 12 (particularly, the first seed layer 12A) contains three atoms, Ti, Cr, and O, matching of the crystal structure between the recording layer 14 containing Cr and the seed layer 12 is improved. In the case where the underlayer 13 contains Cr, when the seed layer 12 (particularly, the first seed layer 12A) contains three atoms, Ti, Cr, and O, matching of the crystal structure between the underlayer 13 and the seed layer 12 is also improved.

The second seed layer 12B favorably has a crystalline state. The second seed layer 12B favorably contains an alloy containing Ni and W, and is more favorably formed of an alloy containing Ni and W. The alloy may have, for example, an average atomic ratio represented by the following formula (2B). The second seed layer 12B may be formed of, particularly, Ni₉₄W₆.

$${Ni}_{( 100 - x )} {W}_{x} \qquad ( 2 B )$$

(wherein, in the formula (2B), x satisfies, for example, the following relationship: 1≤x≤10, favorably 2≤x≤10, more favorably 4≤x≤8, and still more favorably x=6.)

The seed layer 12 contains oxygen. This is because oxygen derived from or generated from the film forming the base 11 enters the seed layer 12. That is, the seed layer 12 of the magnetic tape MT1 has an atomic configuration different from that of a seed layer of a hard disk (HDD) in which the base 11 including a film is not used.

The average thickness of the first seed layer 12A is, favorably, 0.1 nm or more and 5.0 nm or less, more favorably 1.5 nm or more and 3.0 nm or less, still more favorably 1.7 nm or more and 3.0 nm or less, and particularly favorably 1.7 nm or more and 2.5 nm or less.

The average thickness of the second seed layer 12B is, favorably, 1.0 nm or more and 20.0 nm or less, more favorably 3.0 nm or more and 18.0 nm or less, and still more favorably 5.0 nm or more and 15.0 nm or less.

The average thickness of the seed layer 12 is favorably 1.1 nm or more and 25.0 nm or less, more favorably 5.0 nm or more and 20.0 nm or less, still more favorably 7.0 nm or more and 15.0 nm or less, and particularly favorably 10.0 nm or more and 15.0 nm or less.

The average thickness of the seed layer 12 is obtained as follows. The magnetic tape MT1 is unwound from a reel or the like, and cut into a necessary length at three positions 10 m to 20 m, 30 m to 40 m, and 50 m to 60 m from one end on the outermost periphery side to prepare three samples. Subsequently, each sample is processed by an FIB (Focused Ion Beam) method or the like for slicing. In the case of using an FIB method, a carbon layer and a tungsten layer are formed as protective layers as pre-processing for observing a TEM image of a cross section described below. The carbon layer is formed on the surfaces of the magnetic tape MT1 on the side of the protective layer 16 and on the side of the back layer 18 by a vapor deposition method, and the tungsten layer is further formed on the surface on the side of the protective layer 16 by a vapor deposition method or a sputtering method. The slicing is performed along the length direction (longitudinal direction) of the magnetic tape MT1. That is, the slicing forms a cross section parallel to both the longitudinal direction and the thickness direction of the magnetic tape MT1.

The above cross section of each obtained sliced sample is observed under the following conditions using a transmission electron microscope (TEM) to obtain a TEM image. Note that the magnification and the acceleration voltage may be adjusted as appropriately in accordance with the type of apparatus.
Apparatus: TEM (H9000NAR manufactured by Hitachi, Ltd.)
Acceleration voltage: 300 kV
Magnification: 2,000,000 times

Next, the obtained TEM image of each sliced sample is used to measure the thickness of the seed layer 12 at 10 positions of each sliced sample aligned in the longitudinal direction of the magnetic tape MT1. An average value obtained by simply averaging (arithmetically averaging) the measured values of each obtained sliced sample (total of 30 measured values) is used as the average thickness [nm] of the seed layer 12. Note that the positions where the measurement is performed are randomly selected from the test piece.

The average thickness of the first seed layer 12A and the average thickness of the second seed layer 12B are obtained in the same manner as that for the average thickness of the seed layer 12.

### (Underlayer)

The underlayer 13 is provided between the seed layer 12 and the recording layer 14. The underlayer 13 may have a two-layer structure. That is, the underlayer 13 may include a first underlayer 13A and a second the underlayer 13B in this order on the seed layer 12.

The first underlayer 13A favorably contains ruthenium alone, a ruthenium alloy, or a Co alloy, more favorably ruthenium alone, and is still more favorably formed of ruthenium alone. When the first underlayer 13A contains ruthenium, a ruthenium alloy, or a Co alloy, the lattice matching with the CoCrPt alloy contained in the recording layer 14 is improved. As a result, it is possible to improve the orientation characteristics of the recording layer 14.

The above Co alloy favorably has an average

atomic ratio represented by the following formula (3A).

$${Co}_{( 100 - y )} {Cr}_{y} \qquad ( 3 A )$$

(wherein, in the formula (3A), y satisfies, for example, the following relationship: 35≤y≤45.)

The average thickness of the first underlayer 13A is, favorably, 1.0 nm or more and 50.0 nm or less, more favorably 5.0 nm or more and 50.0 nm or less. In the case where the first underlayer 13A contains ruthenium alone or a ruthenium alloy, the average thickness of the first underlayer 13A is still more favorably 2.0 nm or more and 20.0 nm or less, particularly favorably 2.0 nm or more and 8.0 nm or less or 3.0 nm or more and 7.0 nm or less. In the case where the first underlayer 13A contains a Co alloy, the average thickness of the first underlayer 13A is still more favorably 10.0 nm or more and 50.0 nm or less, still more favorably 20.0 nm or more and 50.0 nm or less, and particularly favorably 25.0 nm or more and 45.0 nm or less. The first underlayer 13A has the role of enhancing the crystal orientation. The crystallographic matching state with the crystals (e.g., NiW crystals contained in the second seed layer 12B) forming the layer immediately below the first underlayer 13A can differ depending on the material forming the first underlayer 13A. For this reason, the favorable average thickness for enhancing the crystal orientation can differ depending on the material forming the first underlayer 13A.

The second the underlayer 13B favorably contains ruthenium alone, a ruthenium alloy, or a Co alloy, more favorably ruthenium alone, and is still more favorably formed of ruthenium alone. The ruthenium crystals have a hexagonal close-packed (hcp) structure. When the second the underlayer 13B contains ruthenium, a ruthenium alloy, or a Co alloy, the lattice matching with the CoCrPt alloy contained in the recording layer 14 is improved. As a result, it is possible to improve the orientation characteristics of the recording layer 14. When the first underlayer 13A contains ruthenium alone or a ruthenium alloy, the second the underlayer 13B favorably contains ruthenium alone or a ruthenium alloy. In the case where the first underlayer 13A contains a Co alloy, the second the underlayer 13B favorably contains a Co alloy.

The above Co alloy favorably contains Cr and a metal oxide. The metal oxide contained in the Co alloy is favorably silicon dioxide (SiO₂) or titanium dioxide (TiO₂). The Co alloy more favorably has an average atomic ratio represented by the following formula (3B).

$${[ {Co}_{( 100 - y )} {Cr}_{y} ]}_{( 100 - z )} {( {MO}_{2} )}_{z} \qquad ( 3 B )$$

(wherein, in the formula (3B), y satisfies, for example, the following relationship: 35≤y≤45, z satisfies, for example, the following relationship: z≤10, and M represents, for example, Si or Ti.)

In the case where z exceeds 10 in the above formula (3B) relating to the second the underlayer 13B, the magnetic columnar crystals (columns) of the Co alloy and non-magnetic grain boundaries that surround the columns and physically and magnetically separate the respective columns from each other are excessive, leading to a structure in which the respective columnar magnetic crystal grains are excessively magnetically separated from each other, which is not favorable.

The average thickness of the second the underlayer 13B is favorably 1.0 nm or more and 30.0 nm or less, more favorably 5.0 nm or more and 25.0 nm or less. In the case where the second the underlayer 13B contains ruthenium alone or a ruthenium alloy, the average thickness of the second the underlayer 13B is still more favorably 10.0 nm or more and 20.0 nm or less, particularly favorably 15.0 nm or more and 20.0 nm or less. In the case where the second the underlayer 13B contains a Co alloy, the average thickness of the second the underlayer 13B is favorably 1.0 nm or more and 30.0 nm or less, more favorably 5.0 nm or more and 25.0 nm or less. The second the underlayer 13B has the role of making the columns of the recording layer 14 have a projecting shape. The average thickness of the second the underlayer 13B is favorably larger in order to make the columns have a projecting shape. However, the larger the average thickness of the second the underlayer 13B, the lower the crystal orientation. In order to balance the function of making the columns have a projecting shape and the crystal orientation, it is favorable that the average thickness is within the above numerical range. Further, since the above balance changes depending on the material forming the second the underlayer 13B, the suitable numerical range for the average thickness can differ depending on the material.

The average thickness of the underlayer 13 is favorably 10.0 nm or more and 60.0 nm or less, more favorably 15.0 nm or more and 55.0 nm or less. In the case where the seed layer 12 contains ruthenium alone or a ruthenium alloy, the average thickness of the underlayer 13 is still more favorably 15.0 nm or more and 40.0 nm or less, particularly favorably 20.0 nm or more and 40.0 nm or less or 20.0 nm or more and 35.0 nm or less. In the case where the underlayer 13 contains a Co alloy, the average thickness of the underlayer 13 is still more favorably 40.0 nm or more and 55.0 nm or less, particularly favorably 45.0 nm or more and 55.0 nm or less.

The average thickness of each of the underlayer 13, the first underlayer 13A, and the second the underlayer 13B is obtained in the same manner as that for the average thickness of the seed layer 12. However, the magnification of the TEM image is adjusted as appropriate in accordance with the thicknesses of the underlayer 13, the second the underlayer 13B, and the first underlayer 13A.

### (Recording Layer)

The recording layer 14 is a layer containing magnetic crystal grains and can function as a layer that records or reproduces signals using magnetism. The recording layer 14 may be a perpendicular magnetic recording layer in which magnetic crystal grains are perpendicularly oriented. Further, from the viewpoint of improving the recording density, the recording layer 14 is favorably a granular magnetic layer having a granular structure containing a Co alloy.

The recording layer 14 having a granular structure includes ferromagnetic crystal grains containing a Co alloy and non-magnetic grain boundaries (non-magnetic material) surrounding the ferromagnetic crystal grains. More specifically, the recording layer 14 having a granular structure includes columns (columnar crystals) containing a Co alloy and non-magnetic grain boundaries that surround the columns and physically and magnetically separate the respective columns from each other. Such a granular structure allows the recording layer 14 to have a structure in which the respective columnar magnetic crystal grains are magnetically separated from each other.

The Co alloy has a hexagonal close-packed (hcp) structure, and its c-axis can be oriented in the perpendicular direction (the thickness direction of the magnetic tape MT) with respect to the main surface of the recording layer 14. When the recording layer 14 has a hexagonal close-packed structure in this way, the orientation characteristics of the recording layer 14 are further enhanced. As the Co alloy, it is favorable to adopt a CoPtCr alloy containing at least Co, Pt, and Cr. The CoPtCr alloy is not particularly narrowly limited and may further include an additive element. Examples of the additive element include at least one element selected from the group consisting of Ni and Ta. Favorably, the recording layer 14 may have a granular structure in which particles containing Co, Pt, and Cr are separated from each other by oxides.

The non-magnetic grain boundaries that surround ferromagnetic crystal grains contain a non-magnetic metal material. Here, the metal includes a semi-metal. The non-magnetic metal material may be, for example, a non-magnetic oxide. As the non-magnetic oxide, at least one of a metal oxide or a metal nitride can be adopted, and a metal oxide is favorably used from the viewpoints of more stably maintaining the above granular structure.

In the case where the ferromagnetic crystal grains contain a CoPtCr alloy, the content of Co in the recording layer 14 is favorably 43.0 at % or more and 54.0 at % or less, more favorably 45.4 at % or more and 52.7 at % or less. In the case where the ferromagnetic crystal grains contain a CoPtCr alloy, the content of Pt in the recording layer 14 is favorably 9.0 at % or more and 17.0 at % or less, more favorably 10.2 at % or more and 15.2 at % or less. In the case where the ferromagnetic crystal grains contain a CoPtCr alloy, the content of Cr in the recording layer 14 is favorably 6.5 at % or more and 14.5 at % or less, more favorably 7.1 at % or more and 13.7 at % or less.

The above metal oxide suitable for non-magnetic grain boundaries contains, for example, at least one element selected from the group consisting of Si, Cr, Co, Cu, Al, Ti, Ta, Zr, Ce, Y, B, and Hf, and O (oxygen). More specifically, for example, the metal oxide contains at least one element selected from the group consisting of SiO₂, Cr₂O₃, CoO, CO₃O₄, CuO, Al₂O₃, TiO₂, Ta₂O₅, ZrO₂, CeO₂, Y₂O₃, B₂O₃, and HfO₂. The metal oxide contains favorably one, two, or three selected from B₂O₃, SiO₂, and TiO₂, more favorably at least one selected from B₂O₃, SiO₂, and TiO₂, and still more favorably B₂O₃.

In the case where the non-magnetic grain boundaries contain an oxide of the metal M (where the metal M contains, for example, at least one element selected from the group consisting of Si, Cr, Co, Cu, Al, Ti, Ta, Zr, Ce, Y, B, and Hf.), the content of the metal M in the recording layer 14 is favorably 13.0 at % or less, more favorably 11.5 at % or less, and still more favorably 6.4 at % or more and 11.5 at % or less. In the case where the oxide of the metal M of the non-magnetic grain boundaries contains Si, the content of Si in the recording layer 14 is 10.0 at % or less, more favorably 9.0 at % or less, and still more favorably 6.4 at % or more and 9.0 at % or less. In the case where the oxide of the metal M of the non-magnetic grain boundaries contains B, the content of B in the recording layer 14 is favorably 9.0 at % or more and 14.0 at % or less, more favorably 11.5 at % or less. In the case where the non-magnetic grain boundaries contain an oxide of the metal M, the content of oxygen in the recording layer 14 is favorably 23.0 at % or less, more favorably 17.2 at % or more and 20.4 at % or less.

The above metal nitride suitable for non-magnetic grain boundaries contains, for example, at least one element selected from the group consisting of Si, Cr, Co, Al, Ti, Ta, Zr, Ce, Y, and Hf. More specifically, for example, the metal nitride contains at least one element selected from the group consisting of SiN, TiN, and AlN.

The reason why it is presumed favorable that the above metal oxide is B₂O₃ will be described below. The role of the non-magnetic grain boundaries in the granular structure is to reduce the effect of exchange interactions acting between the ferromagnetic crystal grains by separating the columns of the Co alloy from each other as described above, i.e., spatially separating the ferromagnetic crystal grains from each other. It has been revealed that the process in which sputtered particles reach the base film and precipitate has a significant effect on the state of this granular structure and a favorable granular structure can be achieved when the melting point of the material forming the non-magnetic grain boundaries is lower than the material forming the ferromagnetic crystal grains. For example, in the case where Co₈₀Pt₂₀ is assumed to be the material of ferromagnetic crystal grains, the melting point thereof is 1450° C. In the case where the non-magnetic grain boundaries are formed of SiO₂ and TiO₂, the melting points are respectively 1600° C. and 1843° C., which are higher than that of Co₈₀Pt₂₀, but the melting point of B₂O₃ is 470° C., which is extremely lower than the melting point of Co₈₀Pt₂₀. In the case where the melting point of the material of the non-magnetic grain boundaries is lower than the melting point of the ferromagnetic crystal grains, the ferromagnetic crystal grains are precipitated first at the tip portion of the column of the underlayer 13, and the material of the non-magnetic grain boundaries is precipitated between the ferromagnetic particles after cooling processes and the temperature drops, thereby realizing a favorable granular structure. In this way, it is conceivable that B₂O₃ is suitable as an oxide in the recording layer 14 (Reference: K. K. Tham, R. Kushibiki, S. Hinata, and S. Saito, “B₂O₃: Grain boundary material for high-Ku CoPt-oxide granular media with low degree of intergranular exchange coupling,” Jpn. J. Appl. Phys., vol. 55, p. 07MC06, June 2016.).

For the reasons described above, in the present technology, the recording layer 14 may favorably have a granular structure including magnetic crystal grains (particularly, columnar magnetic crystal grains) and non-magnetic grain boundaries that surround the magnetic crystal grains. The melting point of the material forming the non-magnetic grain boundaries may be favorably lower, e.g., 100° C. or more lower, more favorably 300° C. or more lower, and still more favorably 500° C. or more, 600° C. or more, or 700° C. or more lower than the melting point of the material forming the magnetic crystal grains. The difference between the melting point of the former and the melting point of the latter may be, for example, 1200° C. or less, 1100° C. or less, or 1000° C. or less. That is, the melting point of the material forming the non-magnetic grain boundaries may be favorably lower, e.g., 100° C. or more and 1200° C. or less lower, more favorably 300° C. or more and 1100° C. or less lower, and still more favorably 500° C. or more and 1000° C. or less lower than the melting point of the material forming the magnetic crystal grains.

The content [at. %] of each atom in the recording layer 14 is obtained as follows.

The recording layer 14 has an average atomic ratio represented by the following formula (I).

$${[ {Co}_{( 100 - X - Y )} {Pt}_{X} C {r}_{Y} ]}_{( 100 - Z )} - {( {MO}_{N} )}_{z} \qquad ( I )$$

wherein, in the formula (I), MON represent a metal oxide.

First, the magnetic tape MT1 is unwound from a reel or the like, and cut into a necessary size at three positions 10 m to 20 m, 30 m to 40 m, and 50 m to 60 m from one end on the outermost periphery side to prepare three samples. Subsequently, the back layer on the back surface (surface on the side of the back layer 18) of each sample is removed with methyl ethyl ketone to obtain three samples. The back surface (surface on the side where the back layer 18 has been removed) of each sample is subjected to FIB (Focused Ion Beam) treatment to remove the base 11, the seed layer 12, and the underlayer 13. In this way, three analysis samples in which only the recording layer 14, the CAP layer 15, the protective layer 16, and the lubricant layer 17 are left are obtained.

For each analysis sample, the inside of the metal column and the boundary between the metal column and the oxide are each observed at five positions using a TEM, and analyzed by an energy-dispersive X-ray spectroscopy (EDX) to identify the average atomic ratio of each element contained in the recording layer 14. The measurement conditions for the TEM and elemental analyzer and a more detailed procedure for identifying the average atomic ratio are shown below.

### (Measurement Conditions for TEM)

Scanning transmission electron microscope: JEM-ARM200F manufactured by JEOL Ltd.
Acceleration voltage: 200 kV
Beam diameter: approximately 0.2 nmΦ
Magnification: 2,000,000 times

### (Measurement Conditions for Elemental Analyzer)

Elemental analyzer: JED-2300T manufactured by JEOL Ltd.
X-ray detector: Si drift detector
Energy solution: approximately 140 eV
X-ray take-off angle: 21.9°
Solid angle: 0.98 sr

### (Procedure for Identifying Average Atomic Ratio)

### (1) Ratio of Co, Pt, and Cr

The inside of the metal column is analyzed at five positions by EDX using the TEM image of the cross section of the recording layer 14 of the above analysis sample to identify the average atomic ratio of Co, Pt, and Cr. In this way, the values of X and Y in the above formula (I) are obtained.

### (2) Quantitative Analysis of M

The inside of the oxide grain boundaries is analyzed at five positions by EDX using the TEM image of the cross section of the recording layer 14 of the above analysis sample to perform quantitative analysis of M in the above formula (I).

### (3) Ratio of M and O

The inside of the oxide grain boundaries is analyzed at five positions by EDX using the TEM image of the cross section of the recording layer 14 of the above analysis sample to identify the average atomic ratio of M and O. In this way, the value of N in the above formula (I) is obtained.

### (4) Ratio of Metal and Oxide

The area ratio of the metal column (black part) and the oxide (white part) in the planar TEM image (field of view including 100 or more columns) is calculated by processing using image analysis software “ImageJ” (available from the National Institutes of Health, USA). The volume ratio of the oxide is obtained on the basis of the area ratio. The element ratio of the oxide to the metal is obtained on the basis of the volume ratio. In this way, the value of Z in the above formula (I) is obtained.

Details of the above processing using ImageJ is shown below.

### (Process of Measuring Black Area by Binarization)

Processing is performed using ImageJ as follows. In the processing, the image processing range is set to 80 nm×80 nm. The specific operation procedure of the software is shown in parentheses in each process below.
Process 1: Open an image file. (File→Open)
Process 2: Input dimensions. (Analyze→Set Scale)

Dimensions are set as follows.
Distance in pixels: 640
Known distance: 64
Pixel aspect ratio: 1.0
Unit of length: μm
Process 3: Convert the image type into an 8-bit grayscale image. (Image (image menu)>Type (image type)>8 bit)
Process 4: Remove noise. (Process (process menu)>Smooth (smoothing))
Process 5: Binarize. (Process (process menu)>Binary (binarize)>Make Binary (make the image black and white))
Process 6: Analyze. (Analyze (analysis menu)->Analyze Particles (particle analysis))

In the analysis, the thresholds value are set as follows.
Size (Pixel\hat{ }2): 100-10000
Circularity: 0.00-1.00
Show: Masks

After setting the threshold values, “Summarize” is checked to display a Summary screen. In the Summary screen, Count (number of particles), Total Area (total of the areas), Average size (number of particles), Area Function (ratio of the area occupied by particles), and Mean (average) are displayed.
Process 7: the above processes 1 to 6 are performed on the images at five positions in the above analysis sample, and an average value (simple average) of the obtained Area Functions (ratio of the area occupied by particles) is calculated. The average value corresponds to the area ratio ((100-Z) in the above formula (I)) of the metal element.

In the identification of the average atomic ratio, assumption is made that cross sections with the same area ratio overlap in the depth direction and the area ratio=the volume ratio. Further, as the oxide specific gravity and the metal specific gravity to be used when obtaining the element ratio from the volume ratio, a bulk value of each element is used.

The average atomic ratio of Co, Pt, Cr, M, and O is identified by the above method.

An average thickness tₘ of the recording layer 14 is favorably 10.0 nm or more and 20.0 nm or less, more favorably 11.0 nm or more and 19.0 nm or less, and still more favorably 12.0 nm or more and 18.0 nm or less.

The average thickness tₘ of the recording layer 14 is obtained in the same manner as that for the average thickness of the seed layer 12. However, the magnification of the TEM image is adjusted as appropriate in accordance with the thickness of the recording layer 14.

### (CAP Layer)

The CAP layer 15 is a layer that contains a material with a strong magnetic interaction. A stacked structure including the recording layer 14 having a granular structure and the CAP layer 15 is generally referred to as Coupled Granular Continuous (CGC).

The CAP layer 15 may contain a CoPtCr material. Examples of the CoPtCr material include a CoPtCr material, a CoPtCrB material, and a material obtained by further adding a metal oxide to these materials (CoPtCr-metal oxide, CoPtCrB-metal oxide). Examples of the metal oxide (e.g., MON in the following formula (4B)) to be added to the materials include at least one selected from the group consisting of Si, Ti, Mg, Ta, and Cr. More specifically, for example, the metal oxide contains Sio₂, TiO₂, MgO, Ta₂O₅, Cr₂O₃, or a mixture of two or more of these. The CAP layer 15 favorably contains a CoPtCrB material. That is, the CAP layer 15 is favorably a layer that contains an alloy containing Co, Pt, Cr, and B.

The CAP layer 15 favorably has, for example, an average atomic ratio represented by the following formula (4A) or (4B).

$${Co}_{( 100 - x - y - z )} {Pt}_{x} {Cr}_{y} {B}_{z} \qquad ( 4 A )$$

(wherein, in the formula (4A), x satisfies, for example, the following relationship: 5≤x≤30, y satisfies, for example, the following relationship: 5≤y≤20, and z satisfies, for example, the following relationship: 0≤z≤15, favorably 10≤z≤30.)

$${( {Co}_{( 100 - x - y - z )} {Pt}_{x} {Cr}_{y} {B}_{z} )}_{100 - p} - {( MON )}_{p} \qquad ( 4 B )$$

(wherein, in the formula (4B), x satisfies, for example, the following relationship: 5≤x≤30, y satisfies, for example, the following relationship: 5≤y≤20, z satisfies, for example, the following relationship: 0≤z≤15, favorably 5≤z≤12, MON represents the above metal oxide, and p satisfies, for example, the following relationship: 5≤p≤15.)

The average thickness of the CAP layer 15 is favorably 3.0 nm or more, more favorably 4.0 nm or more, and still more favorably 5.0 nm or more. When the average thickness of the CAP layer 15 is 3.0 nm or more, it is possible to obtain a higher SNR and reduce a saturation magnetic field (Hs) of the recording layer 14. The average thickness of the CAP layer 15 is favorably 10.0 nm or less. When the average thickness of the CAP layer 15 is 10.0 nm or less, it is possible to obtain a higher SNR.

The average thickness of the CAP layer 15 is obtained in the same manner as that for the average thickness of the seed layer 12. However, the magnification of the TEM image is adjusted as appropriate in accordance with the thickness of the CAP layer 15.

### (Protective Layer)

The protective layer 16 is a layer that serves to protect the recording layer 14 and the CAP layer 15. The protective layer 16 contains, for example, carbon or silicon dioxide (SiO₂). It is favorable to contain carbon from the viewpoint of the film strength of this protective layer 16. The carbon includes, for example, at least one selected from the group consisting of graphite, diamond-like carbon (abbreviated as DLC), and diamond.

The average thickness of the protective layer 16 is favorably 1.0 nm or more and 10.0 nm or less, more favorably 2.0 nm or more and 8.0 nm or less, and still more favorably 3.0 nm or more and 6.0 nm or less.

The average thickness of the protective layer 16 is obtained in the same manner as that for the average thickness of the seed layer 12. However, the magnification of the TEM image is adjusted as appropriate in accordance with the thickness of the protective layer 16. Further, in the case where the protective layer 16 is formed of carbon and a carbon layer is formed as a protective layer when preparing a sample in the pre-processing for observing the TEM image of the above cross section, it is impossible to distinguish the protective layer 16 and the protective layer when preparing the sample from each other in some cases. Therefore, in the case where the protective layer 16 is formed of carbon, it does not necessarily need to form a carbon layer as a protective layer when preparing a sample on the surface of the sample on the side of the protective layer 16.

### (Lubricant Layer)

The lubricant layer 17 is a layer including a lubricant and has mainly a function of reducing the friction of the magnetic tape MT1 during travelling. The lubricant layer 17 includes at least one type of lubricant. The lubricant layer 17 may further include, as necessary, various additives such as a rust inhibitor. The lubricant has at least two carboxyl groups and one ester bond, and includes at least one type of carboxylic acid compound represented by the following general formula (a). The lubricant may further include a lubricant other than the carboxylic acid compound represented by the following general formula (a).

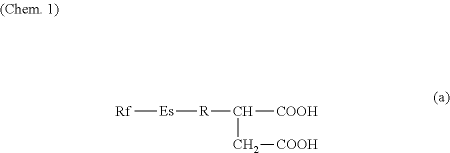

(in the above general formula (a), Rf represents an unsubstituted or substituted and saturated or unsaturated fluorine-containing hydrocarbon group or hydrocarbon group, Es represents an ester bond, and R represents an unsubstituted or substituted and saturated or unsaturated hydrocarbon group although it does not necessarily need to be present.)

The above carboxylic acid compound is favorably one represented by the following general formula (b) or general formula (c).

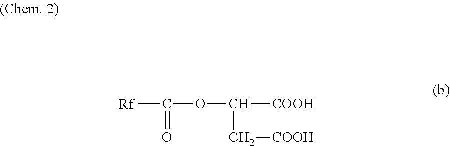

(in the general formula (b), Rf represents an unsubstituted or substituted and saturated or unsaturated fluorine-containing hydrocarbon group or hydrocarbon group.)

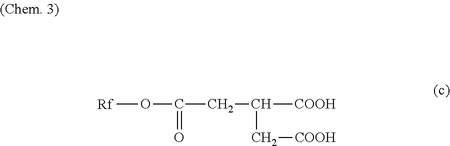

(in the general formula (c), Rf represents an unsubstituted or substituted and saturated or unsaturated fluorine-containing hydrocarbon group or hydrocarbon group.)

The lubricant favorably includes one or both of the carboxylic acid compounds represented by the above general formula (b) and general formula (c).

When the lubricant that includes the carboxylic acid compound represented by the general formula (a) is applied to the recording layer 14, the protective layer 16, or the like, a lubricating effect is exhibited due to the cohesive force between fluorine-containing hydrocarbon groups or hydrocarbon groups Rf, which are hydrophobic groups. In the case where the Rf group is a fluorine-containing hydrocarbon group, it is favorable that the total number of carbon atoms is 6 or more and 50 or less and the total number of carbon atoms in the fluorinated hydrocarbon group is 4 or more and 20 or less. The Rf group may be saturated or unsaturated, and linear, branched, or cyclic, but is particularly favorably saturated and linear.

For example, in the case where the Rf group is a hydrocarbon group, it is desirably a group represented by the following general formula (d).

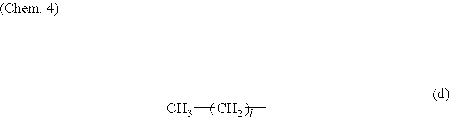

(where, in the general formula (d), l represents an integer selected from the range of 8 or more and 30 or less, more desirably 12 or more and 20 or less.

Further, in the case where the Rf group is a fluorine-containing hydrocarbon group, it is desirably a group represented by the following general formula (e).

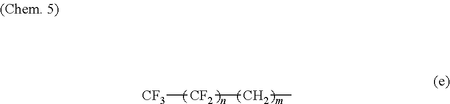

(where, in the general formula (e), m and n are each an integer selected from the following ranges, i.e., m is 2 or more and 20 or less, n is 3 or more 18 or less, more desirably, m is 4 or more and 13 or less, and n is 3 or more and 10 or less.)

The fluorinated hydrocarbon group may be concentrated in one place as described above or dispersed as shown in the following general formula (f), and may be not only —CF₃ or —CF₂— but also —CHF₂, —CHF—, or the like.

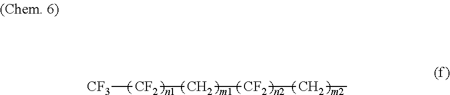

(where, in the general formula (f), n1+n2=n, m1+m2=m.)

The reason why the number of caron atoms in the general formulae (d), (e), and (f) is limited as described above is that when the number of caron atoms (1 or the sum of m and n) forming an alkyl group or fluorine-containing alkyl group is equal to or greater than the above lower limit, the length is appropriate, the cohesive force between hydrophobic groups is effective exhibited, a favorable lubricating effect is exhibited, and the friction/wear durability is improved. Further, when the number of caron atoms is equal to or less than the above upper limit, the favorable solubility of the lubricant including the above carboxylic acid compound in the solvent is maintained.

In particular, in the case where the Rf group contains a fluorine atom, it is effective in reducing the friction coefficient and improving the travelling performance. However, it is favorable to provide a hydrocarbon group between the fluorine-containing hydrocarbon group and the ester bond to separate the fluorine-containing hydrocarbon group and the ester bond from each other, and ensure high stability of the ester bond to suppress hydrolysis. Further, the Rf group may be one having a fluoroalkylether group or a perfluoropolyether group. The R group is favorably a hydrocarbon chain with a relatively small number of caron atoms although it does not necessarily need to be present. Further, the Rf group or the R group may contain, as a constituent element, an element such as nitrogen, oxygen, sulfur, phosphorus, and halogen, and may further have a hydroxyl group, a carboxyl group, a carbonyl group, an amino group, and an ester bond in addition to the above-mentioned functional group.

Specifically, the above carboxylic acid compound represented by the general formula (a) is favorably at least one of the compounds shown below. That is, the lubricant favorably includes at least one of the compounds shown below.

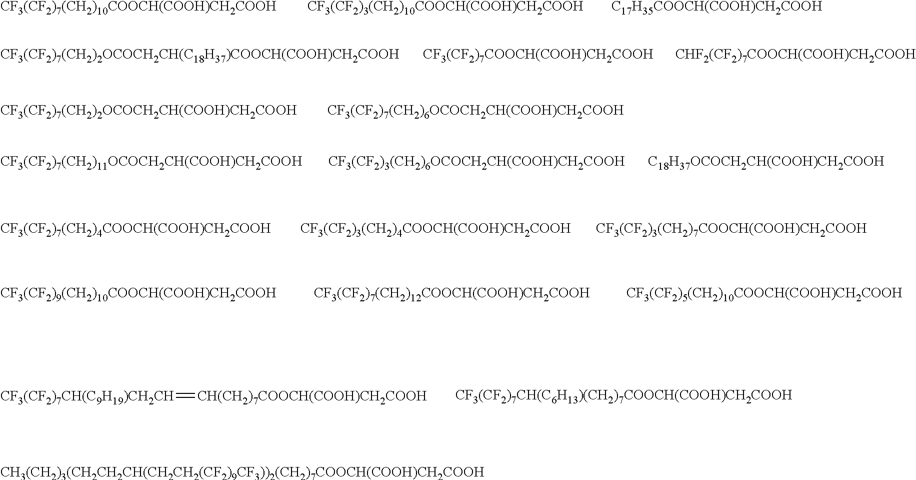

The above carboxylic acid compound represented by the general formula (a) is soluble in a non-fluorine solvent that has a small environmental impact and has the advantage that it can be applied, immersed, sprayed, etc., using a general-purpose solvent such as a hydrocarbon solvent, a ketone solvent, an alcohol solvent, and an ester solvent. Specific examples of the solvent include hexane, heptane, octane, decane, dodecane, benzene, toluene, xylene, cyclohexane, methyl ethyl ketone, methylisobutylketone, methanol, ethanol, isopropanol, diethylether, tetrahydrofuran, dioxane, and cyclohexanone.

In the case where the protective layer 16 contains carbon, when the above carboxylic acid compound is applied as a lubricant to the protective layer 16, the two carboxyl groups and the at least one ester bond group, which are polar group portions of the lubricant molecule, are adsorbed onto the protective layer 16, and the lubricant layer 17 with a particularly favorable durability can be formed by the cohesive force between the hydrophobic groups.

Note that the lubricant may not only be held as the lubricant layer 17 on the surface of the magnetic tape MT1 as described above but also be included and held in the layer such as the recording layer 14 and the protective layer 16 constituting the magnetic tape MT1.

### (Back Layer)

The back layer 18 plays a role in controlling the friction that occurs when the magnetic tape MT1 travels at high speed while facing the magnetic head, a role in preventing the magnetic tape MT1 from being distorted, and the like. That is, it plays a basic role in causing the magnetic tape MT1 to stably travel at high speed.

The back layer 18 may include a binder and a non-magnetic powder. The back layer 18 may further include, as necessary, at least one additive selected from the group consisting of a lubricant, a curing agent, and an antistatic agent. As the binder, a resin having a structure in which a cross-linking reaction is given to a polyurethane resin, a vinyl chloride resin, or the like. However, the binder is not limited thereto, and another resin may be appropriately blended in accordance with the physical properties required for the magnetic tape MT1, or the like. The resin to be blended is not particularly limited as long as it is a resin generally used in the coating type magnetic tape.

The binder includes, for example, at least one selected from the group consisting of polyvinyl chloride, polyvinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, nitrocellulose), a styrene butadiene copolymer, a polyester resin, an amino resin, and synthetic rubber.

Further, the above binder may include a thermosetting resin or a reactive resin, and may include, for example, at least one selected from the group consisting of a phenolic resin, an epoxy resin, a urea resin, a melamine resin, an alkyd resin, a silicone resin, a polyamine resin, and a urea formaldehyde resin.

Further, a polar functional group such as —SO₃M, —OSO₃M, —COOM, and P═O (OM)₂ may be introduced into the above-mentioned binders for the purpose of improving dispersibility of the magnetic powder. Here, M in the formula represents a hydrogen atom or an alkali metal such as lithium, potassium, and sodium.

Examples of the above polar functional group include a side chain type having a terminal group represented by —NR1R2 or —NR1R2R3⁺X⁻, and a main chain type represented by >NR1R2⁺X⁻. Here, R1, R2, and R3 in the formula each represent a hydrogen atom or a hydrocarbon group, and X⁻ represents a halogen element ion such as fluorine, chlorine, bromine, and iodine or an inorganic or organic ion. Further, examples of the polar functional group include —OH, —SH, —CN, and an epoxy group.

The non-magnetic powder that can be included in the back layer 18 includes, for example, at least one selected from the group consisting of an inorganic particle and an organic particle. One type of non-magnetic powder may be used alone, or two or more types of non-magnetic powders may be used in combination. The inorganic particle includes, for example, one selected from a metal, a metal oxide, a metal carbonate, a metal sulfate, a metal nitride, a metal carbide, and a metal sulfide or a combination of two or more of these. More specifically, the inorganic particle may be, for example, one or two or more selected from iron oxyhydroxide, hematite, titanium oxide, and carbon black. Examples of the shape of the non-magnetic powder include, but not particularly limited to, various shapes such as a needle shape, a spherical shape, a cubic shape, and a plate shape.

The average particle size of the non-magnetic powder that can be included in the back layer 18 is favorably 10 nm or more and 150 nm or less, more favorably 15 nm or more and 110 nm or less. The non-magnetic powder may include a non-magnetic powder having two or more granularity distributions.

As a curing agent, for example, a polyisocyanate can be applied. Examples of the polyisocyanate include aromatic polyisocyanate such as an adduct of tolylene diisocyanate (TDI) and an active hydrogen compound and aliphatic polyisocyanate such as an adduct of hexamethylene diisocyanate (HMDI) and an active hydrogen compound.

The lubricant that can be included in the back layer 18 is similar to that in the above-mentioned lubricant layer 17. That is, the description for the lubricant included in the lubricant layer 17 also applies to the lubricant that can be included in the back layer 18. As the antistatic agent that can be included in the back layer 18, a commercially available antistatic agent can be used, and it is possible to prevent dirt and dust from adhering to the back layer 18 by adding the antistatic agent.

The upper limit value of the average thickness of the back layer 18 is favorably 0.6 μm or less. When the upper limit value of the average thickness of the back layer 18 is 0.6 μm or less, it is possible to maintain the travelling stability of the magnetic tape MT1 in the recording/reproduction apparatus. The lower limit value of the average thickness of the back layer 18 is not particularly limited, but is, for example, 0.2 μm or more. When the lower limit value of the average thickness of the back layer 18 is less than 0.2 μm, there is a risk that the travelling stability of the magnetic tape Tl in the recording/reproduction apparatus is impaired.

The average thickness of the back layer 18 is obtained as follows. First, the average thickness t_{T} [μm] of the magnetic tape MT1 is measured. The method of measuring the average thickness t_{T} of the magnetic tape MT1 is as described above. Subsequently, the back layer 18 of the sample is removed with a solvent such as MEK (methyl ethyl ketone) and dilute hydrochloric acid. After that, the thickness of the sample is measured at five positions using the above Laser Hologage again, and the measured values are simply averaged (arithmetically averaged) to calculate an average value t_{B} [μm] of the magnetic tape MT1 from which the back layer 18 has been removed. Note that the measurement positions are randomly selected from the sample. After that, an average thickness t_{b} [μm] of the back layer 18 is obtained by the following formula.

$${t}_{b} [ µm ] = {t}_{T} [ µm ] - {t}_{B} [ µm ]$$

(Nucleation Magnetic Field Hn and Parameter (Mrt)^{0.5}×f(Hs))

A nucleation magnetic field Hn of the magnetic tape MT1 satisfies the following relationship: Hn≥0 [Oe] and the magnetic tape MT1 satisfies the relationship of the following formula (1).

$${( Mrt )}^{0.5} \times f ( Hs ) \geq 0.7 \qquad ( 1 )$$

(wherein, in the formula (1), Mrt represents the product of a residual magnetization amount Mr of the magnetic tape MT1 and a thickness t of the recording layer 14. Hs represents the saturation magnetic field of the magnetic tape MT1. In a case where Hs≤8500 [Oe], f(Hs)=1.00, and in a case where Hs>8500 [Oe], f(Hs)=1/(1+(Hs−8500)/8500).)

The nucleation magnetic field Hn and the parameter (Mrt)^{0.5}×f(Hs) can each be set to a predetermined value by, for example, adjusting the composition of each material included in the recording layer 14, the content of oxygen contained in the recording layer 14, the thickness of the recording layer 14, and the presence or absence of the CAP layer 15.

As described above, when the nucleation magnetic field Hn of the magnetic tape MT1 satisfies the following relationship: Hn≥0 [Oe] and the magnetic tape MT1 satisfies the relationship of the above formula (1), it is possible to increase the output of the reproduction signal of the magnetic tape MT1. Therefore, it is possible to increase the SNR of the magnetic tape MT1.

From the viewpoint of further increasing the output of the reproduction signal, the nucleation magnetic field Hn of the magnetic tape MT1 satisfies the following relationship: favorably Hn≥100 [Oe], more favorably Hn≥200 [Oe], and still more favorably Hn≥300 [Oe], Hn≥400 [Oe], or Hn≥500 [Oe].

From the viewpoint of further increasing the output of the reproduction signal, the magnetic tape MT1 satisfies the following relationship: favorably the relationship of the following formula (1B), more favorably the relationship of the following formula (1A), still more favorably the relationship of the following formula (1C), and particularly favorably the relationship of the following formula (1D).

$${( Mrt )}^{0.5} \times f ( Hs ) \geq 0.75 \qquad ( 1 B )$$

$${( Mrt )}^{0.5} \times f ( Hs ) \geq 0.8 \qquad ( 1 A )$$

$${( Mrt )}^{0.5} \times f ( Hs ) \geq 0.85 \qquad ( 1 C )$$

$${( Mrt )}^{0.5} \times f ( Hs ) \geq 0.9 \qquad ( 1 D )$$

The numerical range in the formula (1) was derived on the basis of the results of a study on the magnetic field generated by a ring-type recording head 30 and saturation recording. The numerical range of the nucleation magnetic field Hn was derived on the basis of the results of a study on the demagnetization phenomenon caused by the leakage magnetic field from the ring-type recording head 30. Details of these studies will be described below.

### (Study on Magnetic Field Generated by Ring-Type Recording Head and Saturation Recording)

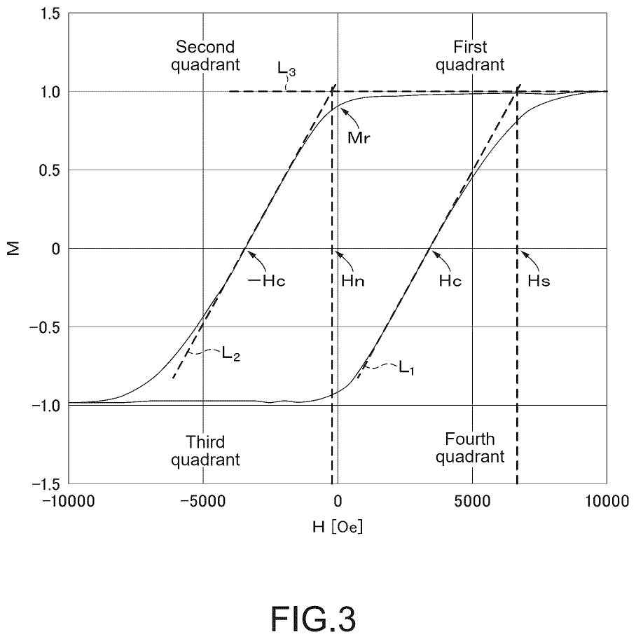

Part A of FIG. 2 is a schematic diagram showing a recording magnetic field generated in the recording head 30 and illustrates a case where the recording head 30 records information on the recording layer 14. Part B of FIG. 2 is a cross-sectional view taken along the line IIB-IIB of Part A of FIG. 2. FIG. 3 is a diagram showing an example of an M-H loop of the magnetic tape MT1 in the perpendicular direction. Note that in FIG. 3, a magnetization amount M is normalized by a saturation magnetization amount Ms, and the unit of the vertical axis is a dimensionless quantity.

The recording head 30 is an example of a ring-type recording head. In Part A of FIG. 2, arrows H each represent a recording magnetic field (magnetic field generated) from the recording head 30. Arrows DM each represent the recording magnetization of a column (columnar crystal) 33 included in the recording layer 14 of the magnetic tape MT1. The recording head 30 includes a core 31 and a coil 32. The coil 32 is wound around the recording head 30. A High Bs layer 31A is provided at the tip of the core 31 (portion forming a gap portion).

The recording head 30 is configured to be capable of controlling the direction of the magnetic field H generated in the recording head 30 by the direction of a signal current flowing through the coil 32. As the magnetic field H generated in the recording head 30 approaches from a surface 31S of the recording head 30 to a surface of the recording layer 14, it approaches more perpendicular to the surface of the recording layer 14. The magnetic field (magnetic field effectively acting on the magnetic material) H acting inside the recording layer 14 is substantially perpendicular to the surface of the recording layer 14.

In order to perform saturation recording in the magnetic tape MT1, it is necessary to apply the magnetic field H exceeding a saturation magnetic field Hs to the magnetic tape MT1 by the recording head 30. That is, the conditions for saturation recording in the recording layer 14 is represented by the following relationship: Hx≥Hs, Hx representing the magnetic field acting inside the recording layer 14, Hs representing the saturation magnetic field. The current data storage tape drive uses the ring-type recording head 30, and the magnetic field H effective for recording in a standard ring-type recording head 30 is approximately 8500 [Oe]. Therefore, it is conceivable that in the case where the saturation magnetic field Hs of the magnetic tape MT1 satisfies the following relationship: Hs>8500 [Oe], sufficient saturation recording cannot be performed. In general, it is known that the reproduction output of a recording signal is proportional to Mrt that is the product of the residual magnetization amount Mr and thickness t of the recording layer 14. In accordance with the knowledge of the present inventors, the reproduction output of the recording signal is experimentally correlated with (Mrt)^{0.5}.

However, in accordance with the findings of the present inventors, the correlation between the reproduction output of the recording signal and (Mrt)^{0.5} is high in the case where Hs≤8500 [Oe], whereas the correlation between the reproduction output of the recording signal and (Mrt)^{0.5} is not high in the case where Hs>8500 [Oe]. In this regard, the present inventors have conducted extensive research to find parameters that are highly correlated with the reproduction output of the recording signal in both the ranges of Hs≤8500 [Oe] and Hs>8500 [Oe]. As a result, the present inventors have found that the reproduction output of the recording signal is highly correlated with (Mrt)^{0.5}×f(Hs) that is the product of (Mrt)^{0.5} and a function f(Hs) that takes into account the degree of saturation recording (however, in a case where Hs≤8500 [Oe], f(Hs)=1.00, and in a case where Hs>8500 [Oe], f(Hs)=1/(1+(Hs−8500)/8500).).

The present inventors have further conducted extensive research on the range of the parameter (Mrt)^{0.5}×f(Hs) that is capable of increasing the reproduction output of the recording signal. As a result, they have found that the reproduction output of the recording signal can be increased by satisfying the following relationship: (Mrt)^{0.5}×f(Hs)≥0.70.

(Study on Demagnetization Phenomenon Caused by Leakage Magnetic Field from Ring-Type Recording Head)

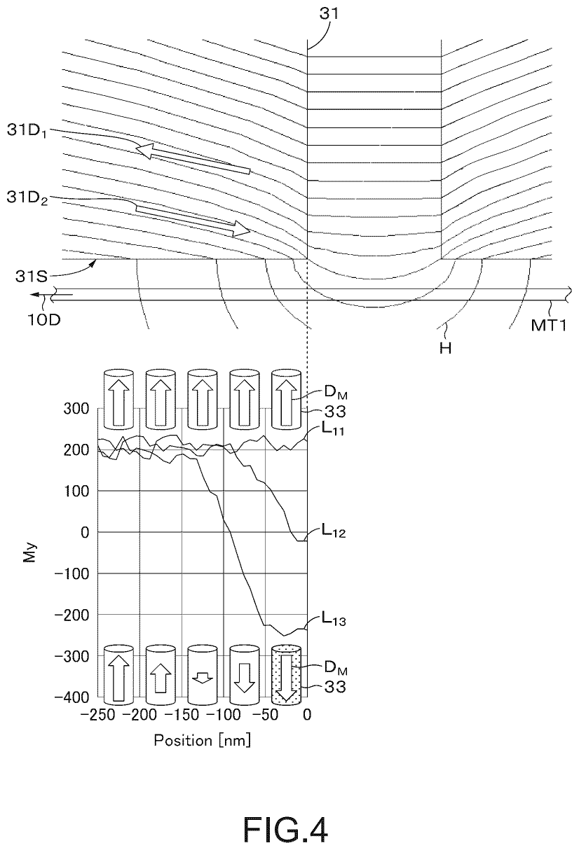

FIG. 4 is a diagram showing an example of a change in magnetization when a head magnetic field is reversed. In the graph in FIG. 4, a curve L₁₁ indicates a magnetization M before the head magnetic field is reversed, a curve L₁₂ indicates the magnetization M during the reversal of the head magnetic field, and a curve L₁₃ indicates the magnetization M after the head magnetic field is reversed. An arrow 10D indicates the travelling direction of the magnetic tape MT1. In the ring-type recording head 30, part of recording magnetization D_{M} that has been recorded is weakened or erased by the leakage magnetic field when the recording head 30 is at an adjacent bit position.

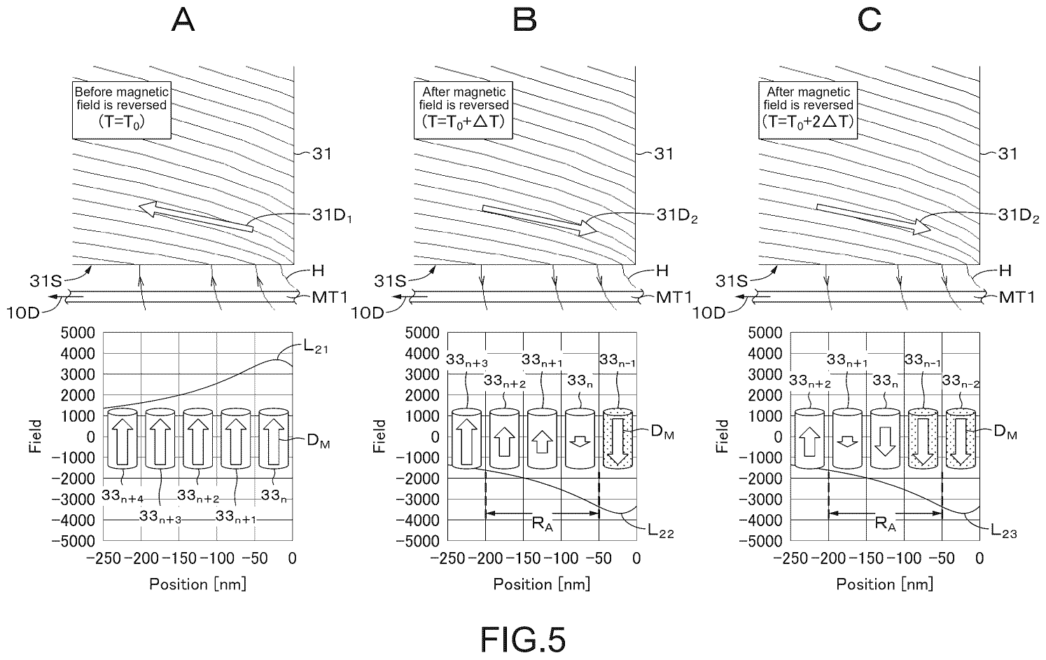

An example of the change in the state of the recording magnetization D_{M} before and after the head magnetic field is reversed will be described with reference to Part A of FIG. 5, Part B of FIG. 5, and Part C of FIG. 5.

The upper diagram of Part A of FIG. 5 is a diagram showing an example of the magnetic field H of the recording head 30 before the head magnetic field is reversed (time T=T₀). The lower diagram of Part B of FIG. 5 is a graph showing an example of the strength of the magnetic field H acting on columns 33ₙ to 33ₙ₊₄ before the head magnetic field is reversed (time T=T₀). The graph also shows an example of the recording magnetization D_{M} of the columns 33ₙ to 33ₙ₊₄ before the head magnetic field is reversed (time T=T₀).

The upper diagram of Part B of FIG. 5 is a diagram showing an example of the magnetic field H of the recording head 30 after the head magnetic field is reversed (time T=T₀+ΔT). The lower diagram of Part B of FIG. 5 is a graph showing an example of the strength of the magnetic field H acting on columns 33ₙ₋₁ to 33ₙ₊₃ after the head magnetic field is reversed (time T=T₀+ΔT). The graph also shows an example of the recording magnetization D_{M} of the columns 33ₙ₋₁ to 33ₙ₊₃ after the head magnetic field is reversed (time T=T₀+ΔT).

The upper diagram of Part C of FIG. 5 is a diagram showing an example of the magnetic field H of the recording head 30 after the head magnetic field is reversed (time T=T₀+2ΔT). The lower diagram of Part B of FIG. 5 is a graph showing an example of the strength of the magnetic field H acing on columns 33ₙ₋₂ to 33ₙ₊₂ after the head magnetic field is reversed (time T=T₀+2ΔT). The graph also shows an example of the recording magnetization D_{M} of the columns 33ₙ₋₂ to 33ₙ₊₂ after the head magnetic field is reversed (time T=T₀+2ΔT).

In Part A of FIG. 5, a curve L₂₁ indicates the strength of the magnetic field H before the head magnetic field is reversed (time T=T₀), in Part B of FIG. 5, a line L₂₂ indicates the strength of the magnetic field H after the head magnetic field is reversed (time T=T₀+ΔT), and in Part C of FIG. 5, a curve L₂₃ indicates the strength of the magnetic field H after the head magnetic field is reversed (time T=T₀+2ΔT). Here, the strength of the magnetic field H represents the strength of the magnetic field H at a position in the vicinity of the surface 31S of the recording head 30. The columns 33ₙ₋₂ to 33ₙ₊₄ indicates columns that passes in the vicinity of the surface 31S of the recording head 30. The arrow 10D indicates the travelling direction of the magnetic tape MT1.

In the following description, the upward direction represents a direction from the back surface of the magnetic tape MT1 toward the magnetic surface, which is parallel to the thickness direction of the magnetic tape MT1, and the downward direction represents a direction from the magnetic surface of the magnetic tape toward the back surface, which is parallel to the thickness direction of the magnetic tape MT1. The back surface of the magnetic tape MT1 represents the surface on the side where the back layer 18 is provided, and the magnetic surface of the magnetic tape MT1 represents the surface on the side where the protective layer 16 is provided.

As shown in Part A of FIG. 5, the recording head 30 before the magnetic field is reversed (time T=T₀) generates a magnetic field in the direction indicated by an arrow 31D₁. As a result, the magnetic field H that is directed toward the upward direction acts on the magnetic tape MT1, and the column 33ₙ of the recording layer 14 is magnetized in the upward direction. Note that the columns 33ₙ₊₁ to 33ₙ₊₄ are magnetized in the upward direction before the magnetization of the column 33ₙ in the same manner as that described for the magnetization of the column 33ₙ.

As shown in Part B of FIG. 5, the recording head 30 after the magnetic field is reversed (time T=T₀+ΔT) generates the magnetic field H in a direction indicated by an arrow 31D₂. As a result, the magnetic field H that is directed toward the downward direction acts on the column 33ₙ₋₁, and the column 33ₙ₋₁ is magnetized in the downward direction. At this time, the magnetic field H that is directed toward the downward direction (the magnetic field H within the range of a region R_{A}) also acts on the columns 33ₙ to 33ₙ₊₂. For this reason, the columns 33ₙ to 33ₙ₊₂ are also magnetized in the downward direction, and the recording magnetization D_{M} of each of the columns 33ₙ to 33ₙ₊₂ is weakened or erased.

As shown in Part C of FIG. 5, when the recording head 30 maintains the magnetic field H in the direction indicated by the arrow 31D₂ even after a predetermined time elapses since the magnetic field is reversed (time T=T₀+2ΔT), the columns 33ₙ and 33ₙ₊₁ are further magnetized in the downward direction. As a result, the recording magnetization D_{M} of each of the columns 33ₙ and 33ₙ₊₁ further changes.

As described above, when the magnetic field is reversed, the recording magnetization D_{M} of each of the columns 33ₙ to 33ₙ₊₃, of the columns 33ₙ to 33ₙ₊₄ magnetized in the upward direction, is weakened or erased. For this reason, the magnetization amount after recording is not the residual magnetization amount Mr but the magnetization amount remaining after being partly weakened or erased by the magnetic field in the opposite direction after unsaturation recording. As a result, the reproduction output is reduced.

The present inventors have conducted extensive research to suppress the effects of the leakage magnetic field when the magnetic field is reversed on the decrease in the recording magnetization Dy and the erasure. As a result, they have found that by setting the nucleation magnetic field Hn to satisfy the relationship: Hn≥0 [e], it is possible to suppress the effects of the leakage magnetic field when the magnetic field is reversed on the decrease in the recording magnetization D_{M} and the erasure, and increase the reproduction output.

### (Method of Measuring Product Mrt of Residual Magnetization Amount Mr and Thickness t of Recording Layer, Saturation Magnetic Field Hs, and Nucleation Magnetic Field Hn)

The product Mrt of the residual magnetization amount Mr and the thickness t of the thickness t of the recording layer 14 the saturation magnetic field Hs, and the nucleation magnetic field Hn are measured as follows. First, the magnetic tape MT1 is unwound from a reel or the like, and one sample is cut out at a position 30 m to 40 m from one end on the outermost periphery side. The cut sample is punched out with a φ6.39 mm punch to prepare a measurement sample. Next, an M-H loop of the measurement sample (entire magnetic tape MT1) corresponding to the perpendicular direction (thickness direction) of the magnetic tape MT1 is measured using a VSM. Next, the back layer 18 of the sample cut out at the 30 m to 40 m position is wiped off with acetone, ethanol, or the like, and the layers other than the back layer 18 are further wiped off with hydrochloric acid, leaving only the base 11. Next, adhesive tape is applied to the front and back of the left base 11 to reinforce it, and then, it is punched out with a φ6.39 mm punch to obtain a sample for background correction (hereinafter, referred to simply as a “correction sample”.). After that, the M-H loop of the correction sample (base 11) corresponding to the perpendicular direction of the base 11 (perpendicular direction of the magnetic tape MT1) is measured using a VSM.

The measuring apparatus and the measurement conditions for the M-H loop of the measurement sample (entire magnetic tape MT1) and the M-H loop of the correction sample (base 11) are as follows.

### (Measuring Apparatus)

Vibrating sample magnetometer “7400-0R” manufactured by Lake Shore Cryotronics, Inc.

### (Measurement Conditions)

Measurement mode: full loop
Maximum magnetic field: 15 kOe
Magnetic field Step: 500 Oe
Time constant: 0.1 sec
MH average number: 10

After the M-H loop of the measurement sample (entire magnetic tape MT1) and the M-H loop of the correction sample (base 11) are obtained as described above, the M-H loop of the correction sample (base 11) is subtracted from the M-H loop of the measurement sample (entire magnetic tape MT1) to perform background correction, thereby obtaining the M-H loop after background correction (see FIG. 3). The measurement/analysis program attached to the vibrating sample magnetometer “7400-0R” is used for this calculation of the background correction.

The M-H loop is drawn such that the magnetic field and the magnetization are positive in the case where a magnetic field is applied in the upward direction to cause magnetization saturation and the magnetic field and the magnetization are negative in the case where a magnetic field is applied in the downward direction to cause magnetization saturation. The above measurement of M-H loops is performed at 25° C.±2° C. and 50% RH±5% RH. Further, the “demagnetizing field correction” when measuring the M-H loop in the perpendicular direction of the magnetic tape MT1 is not performed.

Next, the product Mrt of the residual magnetization amount Mr and the thickness t of the recording layer 14, the saturation magnetic field Hs, and the nucleation magnetic field Hn are obtained as follows using the M-H loop after background correction.

The product Mrt of the residual magnetization amount Mr and the thickness t of the recording layer 14 is obtained as follows. After the residual magnetization amount Mr is obtained from the M-H loop after background correction, the residual magnetization amount Mr [emu] is divided by the area of the measurement sample to calculate the Mrt [mA]. Note that the above measurement/analysis program is used for the calculation of the residual magnetization amount Mr.

The saturation magnetic field Hs is obtained as follows. As shown in FIG. 3, a tangent L₁ is drawn to the M-H loop after background correction at a position of the coercive force Hc on the border between a first quadrant and a fourth quadrant, and a tangent L₃ is drawn to the M-H loop after background correction at a position where the magnetization M is positively saturated in the first quadrant. The strength of the magnetic field H at the intersection of these tangents L₁ and L₃ is obtained and used as the saturation magnetic field Hs. Note that the above measurement/analysis program is used for the calculation of the saturation magnetic field Hs.

The nucleation magnetic field Hn is obtained as follows. As shown in FIG. 3, a tangent L₂ is drawn to the M-H loop after background correction at a position of the coercive force Hc on the border between a second quadrant and a third quadrant, and the tangent L₃ is drawn to the M-H loop after background correction at a position where the magnetization M is positively saturated in the first quadrant. The strength of the magnetic field H at the intersection between these tangents L₂ and L₃ is obtained and used as the nucleation magnetic field Hn. Note that the above measurement/analysis program is used for the calculation of the nucleation magnetic field Hn.

The nucleation magnetic field Hn represents the magnetic field H when the magnetic field H is applied in one direction to sufficiently magnetize the magnetic tape MT1 and then the magnetic field H is reversed to increase the strength of the magnetic field in the opposite direction, causing magnetization reversal.

### [Configuration of Sputtering Apparatus]

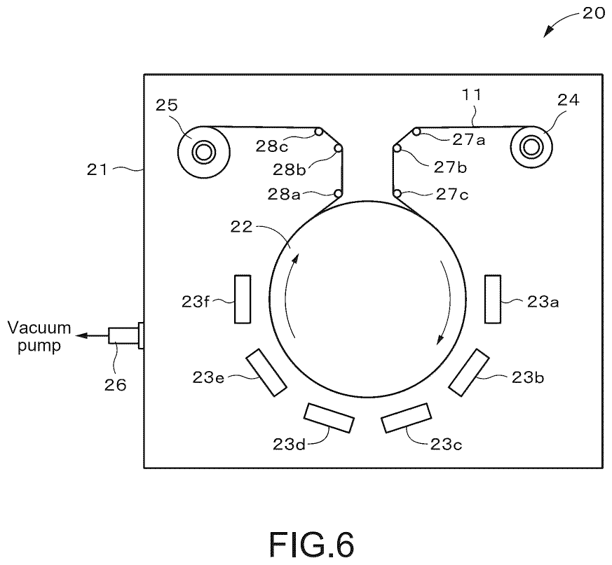

An example of a configuration of a sputtering apparatus 20 to bs used to produce the magnetic tape MT1 according to the first embodiment will be described below with reference to FIG. 6. This sputtering apparatus 20 is a continuous winding sputtering apparatus to be used to deposit the first seed layer 12A, the second seed layer 12B, the first underlayer 13A, the second the underlayer 13B, the recording layer 14, and the CAP layer 15, and includes a deposition chamber 21, a drum 22 that is a metal can (rotation body), cathodes 23a to 23f, a supply reel 24, a take-up reel 25, and a plurality of guide rolls 27a to 27c and 28a to 28c, as shown in FIG. 6. The sputtering apparatus 20 is, for example, a DC (direct current) magnetron sputtering apparatus, but the sputtering method is not limited to this method.

The deposition chamber 21 is connected to a vacuum pump (not shown) via an exhaust port 26, and the atmosphere inside the deposition chamber 21 is set to a predetermined degree of vacuum by this vacuum pump. Inside the deposition chamber 21, the drum 22, the supply reel 24, and the take-up reel 25, which are configured to be rotatable, are disposed. Inside the deposition chamber 21, the plurality of guide rolls 27a to 27c for guiding the conveyance of the base 11 between the supply reel 24 and the drum 22 is provided and the plurality of guide rolls 28a to 28c for guiding the conveyance of the base 11 between the drum 22 and the take-up reel 25 is provided. During sputtering, the base 11 unwound from the supply reel 24 is wound up by the take-up reel 25 via the guide rolls 27a to 27c, the drum 22, and the guide rolls 28a to 28c. The drum 22 has a columnar shape and the long base 11 is conveyed along the columnar circumferential surface of the drum 22. The drum 22 is provided with a cooling mechanism (not shown) and is cooled to, for example, approximately −20° C. during sputtering. Inside the deposition chamber 21, the plurality of cathodes 23a to 23f is disposed to face the circumferential surface of the drum 22. A target is set on each of these cathodes 23a to 23f. Specifically, targets for depositing a SUL 12, the first seed layer 12A, the second seed layer 12B, the first underlayer 13A, the second the underlayer 13B, and the recording layer 14 are respectively set on the cathodes 23a, 23b, 23c, 23d, 23e, and 23f. A plurality of types of films, i.e., the SUL 12, the first seed layer 12A, the second seed layer 12B, the first underlayer 13A, the second the underlayer 13B, and the recording layer 14, are simultaneously deposited by these cathodes 23a to 23f.

In the sputtering apparatus 20 having the above-mentioned configuration, the first seed layer 12A, the second seed layer 12B, the first underlayer 13A, the second the underlayer 13B, the recording layer 14, and the CAP layer 15 can be continuously deposited by a roll-to-roll method.

### [Method of Producing Magnetic Tape]

The magnetic tape MT1 according to the first embodiment of the present technology can be produced, for example, as follows.

First, the first seed layer 12A, the second seed layer 12B, the first underlayer 13A, the second the underlayer 13B, the recording layer 14, and the CAP layer 15 are sequentially deposited on the first main surface of the base 11 using the sputtering apparatus 20 shown in FIG. 6. Specifically, the deposition is performed as follows. First, the deposition chamber 21 is evacuated to a predetermined pressure. After that, the targets set on the cathodes 23a to 23f are sputtered while introducing a process gas such as an Ar gas into the deposition chamber 21. As a result, the first seed layer 12A, the second seed layer 12B, the first underlayer 13A, the second the underlayer 13B, the recording layer 14, and the CAP layer 15 are sequentially deposited on the first main surface of the travelling base 11.

The atmosphere of the deposition chamber 21 during sputtering is set to, for example, approximately 1×10⁻⁵ Pa or more and 5×10⁻⁵ Pa or less. The film thickness and property of each of the SUL 12, the first seed layer 12A, the second seed layer 12B, the first underlayer 13A, the second the underlayer 13B, and the recording layer 14 can be controlled by adjusting the tape line speed at which the base 11 is wound up, the pressure of a process gas such as an Ar gas to be introduced during sputtering (sputtering gas pressure), the input power, and the like.

Next, the protective layer 16 is deposited on the recording layer 14. As the method of depositing the protective layer 16, for example, a chemical vapor deposition (CVD) method or physical vapor deposition (PVD) method can be used.

Next, a binder, an inorganic particle, a lubricant, and the like are kneaded and dispersed in a solvent to prepare a paint for depositing a backcoat layer. Next, the paint for depositing a backcoat layer is applied to the back surface of the base 11 and dried to deposit the back layer 18 on the back surface of the base 11.

Next, for example, a lubricant is applied onto the protective layer 16 to deposit the lubricant layer 17. As the method of applying the lubricant, for example, various application methods such as gravure coating and dip coating can be used. Next, as necessary, the magnetic tape MT1 is cut into a predetermined width. In this way, the magnetic tape MT1 shown in FIG. 1 is obtained.

### [Operation and Effect]

Developments in the field of reproduction output have focused on increasing the sensitivity of reproduction heads, and magnetic tapes have been required to have mainly lower noise. However, the technology for increasing the reproduction output is still important also in the magnetic tapes. In particular, it is important to design the magnetic characteristics taking into account the recoding capacity and recoding process of the recording head in magnetic tapes and take into account the performance of the ring-type recording head in data storage magnetic tapes.

The magnetic tape MT1 according to the first embodiment is configured such that the nucleation magnetic field Hn of the magnetic tape MT1 satisfies the following relationship: Hn≥0 [Oe] and the magnetic tape MT1 satisfies the following relationship: (Mrt)^{0.5}×f(Hs)≥0.70, taking into account the recoding capacity and recoding process of the ring-type recording head 30. As a result, it is possible to increase the reproduction output of the recording signal of the magnetic tape MT1. Therefore, it is possible to increase the SNR of the magnetic tape MT1.

### Modified Example

In the above first embodiment, assuming that sufficient saturation recording cannot be performed by the ring-type recording head 30 in the case where the saturation magnetic field Hs of the magnetic tape MT1 satisfies the relationship: Hs>8500 [Oe], different functions of f(Hs) have been defined for the case where Hs≤8500 [Oe] and the case where Hs>8500 [Oe]. However, the above formula (1) is not limited to this provision. For example, assuming that sufficient saturation recording cannot be performed by the ring-type recording head 30 in the case where the saturation magnetic field Hs of the magnetic tape MT1 is 4300 Bs [Oe], different functions of f(Hs) may be defined for the case where Hs≤4300 Bs [Oe] and the case where Hs>4300 Bs [Oe].

Specifically, the nucleation magnetic field Hn of the magnetic tape MT1 satisfies the following relationship: Hn≥0 [Oe] and the magnetic tape MT1 satisfies the relationship of the following formula (1).

$${( Mrt )}^{0.5} \times f ( Hs ) \geq 0.7 \qquad ( 1 )$$

(wherein, in the formula (1), Mrt represents the product of the residual magnetization amount Mr of the magnetic tape MT1 and the thickness t of the recording layer 14. Hs represents the saturation magnetic field of the magnetic tape MT1. In a case where Hs≤4300 Bs [Oe], f(Hs)=1.00, and in a case where Hs>4300 Bs [Oe], f(Hs)=1/(1+(Hs−4300 Bs)/4300 Bs). Bs represents a saturation magnetic flux density of the core 31 of the recording head 30 used for recording on the magnetic tape MT1, and a unit of Bs is tesla (T).)

A saturation magnetic flux density Bs of the core 31 of the recording head 30 is obtained as follows. First, the vicinity of the gap of the ring-type recording head 30 is processed by FIB or the like for slicing. The above cross section of each obtained sliced sample is observed using a TEM to obtain a cross-sectional TEM image (see Part B of FIG. 2). Next, a measurement position is determined on the basis of the above cross-sectional TEM image, and composition analysis of the constituent material (Co, Fe, and Ni) is performed on the vicinity of the gap of the recording head 30 (High Bs layer 31A) and the core 31 (see Part B of FIG. 2) by EDX. The composition analysis is performed in the same procedure as that for the analysis of each tom in the recording layer 14. A composition Co_{100-X-Y}Fe_{X}Ni_{Y} (wherein, units of X and Y are at %.) of each constituent material is obtained on the basis of the result of the composition analysis. Next, the saturation magnetic flux density Bs of the recording head 30 is obtained by checking Co_{100-X-Y}Fe_{X}Ni_{Y} against the Bs map of the ternary alloy of Co—Fe—Ni. However, as the Bs map of the ternary alloy, the one described in the following literature is used.
R. M. Bozorth, “Ferromagnetism”.p 160, D. Van Nonstrand Company Inc. (1951)

### 2 Second Embodiment

### [Configuration of Magnetic Tape]

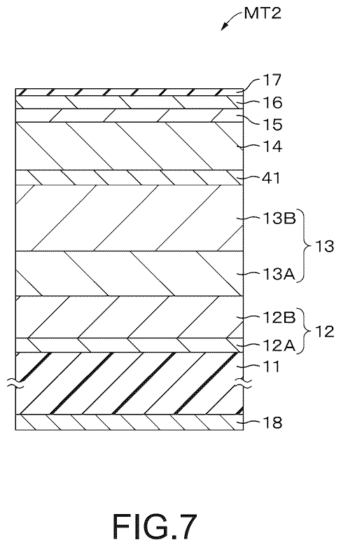

A configuration of a magnetic tape MT2 according to a second embodiment will be described with reference to FIG. 7. The magnetic tape MT2 is, for example, a perpendicular magnetic recording magnetic tape. The magnetic tape MT2 includes the intermediate layer 41 between the underlayer 13 and the recording layer 14 described in the first embodiment (in detail, between the second the underlayer 13B and the recording layer 14). Specifically, in the magnetic tape MT2, the first seed layer 12A and the second seed layer 12B are provided on the first main surface of the long base 11 in this order. The first underlayer 13A and the second the underlayer 13B are provided on the second seed layer 12B in this order. The intermediate layer 41 is provided on the second the underlayer 13B. The recording layer 14 that functions as a magnetic recording layer is provided on the intermediate layer 41. The CAP layer 15, the protective layer 16, and the lubricant layer 17 are provided on the recording layer 14 in this order. Then, the back layer 18 is provided on the second main surface of the base 11. The configuration of the magnetic tape MT2 is as described in the first embodiment except that it includes the intermediate layer 41, and the description also applies to this embodiment.

### (Intermediate Layer)

The intermediate layer 41 is a layer that mainly plays a role of enhancing the orientation characteristics (granularity) of the recording layer 14 formed directly on the intermediate layer 41. The intermediate layer 41 favorably has a crystal structure similar to that of the main component of the recording layer 14 that is in contact with the intermediate layer 41. For example, the intermediate layer 41 contains a material having a hexagonal close-packed structure similar to that of the Co alloy, and the c-axis of the structure is favorably oriented in the direction perpendicular to the main surface of the intermediate layer 41 (thickness direction of the magnetic tape MT1). As a result, it is possible to further increase the crystal-orientation characteristics of the recording layer 14 and make the matching of the lattice constant between the intermediate layer 41 and the recording layer 14 relatively favorable.

The material of having the hexagonal close-packed structure used as the material of the intermediate layer 41 favorably contains Ru. The intermediate layer 41 favorably contains Ru alone or an alloy thereof. The intermediate layer 41 is favorably formed of Ru alone or an Ru alloy. The Ru alloy may be an Ru alloy oxide such as RuCoCr (TiO₂), Ru—SiO₂, RuTiO₂, or Ru—ZrO₂. The Ru alloy can favorably have an average atomic ratio represented by the following formula (5).

$${[ {Ru}_{x} {Co}_{y} {Cr}_{( 100 - x - y )} ]}_{( 100 - z )} {( {MO}_{2} )}_{z} \qquad ( 5 )$$

(wherein, in the formula (5), x satisfies, for example, the following relationship: 10≤x≤40, favorably 15≤x≤35, y satisfies, for example, the following relationship: 20≤y≤50, favorably 25≤y≤45, z satisfies, for example, the following relationship: 1≤z≤30, more favorably 5≤z≤25, and M represents, for example, Ti or Si.)

The Ru material is a rare metal, and it is favorable to make the intermediate layer 41 as thin as possible from the viewpoint of cost to have an average thickness of favorably 6.0 nm or less, more favorably 5.0 nm or less, and still more favorably 2.0 nm or less. Alternatively, from the viewpoint of the cost, a configuration in which the intermediate layer 41 is completely eliminated (e.g., the configuration of the first embodiment) is more favorable.

In the second embodiment, it is possible to obtain a magnetic tape with a favorable SNR by providing the seed layer 12 and the underlayer 13 on the base 11, even in the case where the thickness of the intermediate layer 41 is made thin or a layer form in which the intermediate layer 41 is omitted (e.g., the first embodiment) is adopted.

Note that by utilizing the “wettability” of the intermediate layer 41, the material forming the recording layer 14 formed on the intermediate layer 41 by vacuum deposition can be easily dispersed when crystallizing, and it is possible to increase the column size of crystals. For example, in order to cause the intermediate layer 41 containing Ru to exhibit the wettability, an average thickness of at least 0.5 nm or more is necessary.

### 3 Third Embodiment

### [Configuration of Magnetic Tape]

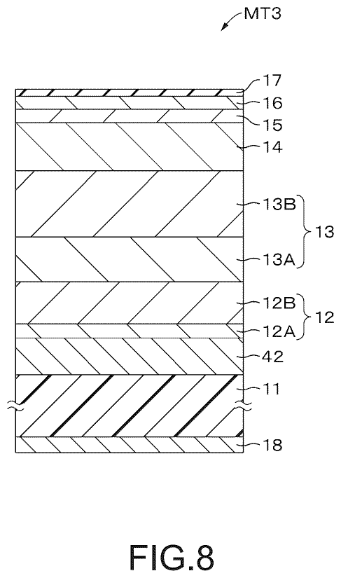

A configuration of a magnetic tape MT3 according to a third embodiment will be described with reference to FIG. 8. The magnetic tape MT3 is, for example, a magnetic tape for perpendicular magnetic recording. The magnetic tape MT3 includes a soft magnetic underlayer (SUL) 42 between the base 11 and the seed layer 12 (in detail, between the base 11 and the first seed layer 12A). More specifically, in the magnetic tape MT3, the SUL 42 is provided on the first main surface of the long base 11. The first seed layer 12A and the second seed layer 12B are provided on the SUL 42 in this order. The first underlayer 13A and the second the underlayer 13B are provided on the second seed layer 12B in this order. The recording layer 14 that functions as a magnetic recording layer is provided on the second the underlayer 13B. The CAP layer 15, the protective layer 16, and the lubricant layer 17 are provided on the recording layer 14 in this order. Then, the back layer 18 is provided on the second main surface of the base 11. The configuration of the magnetic tape MT3 is as described in the first embodiment except that it includes an SUL, and the description also applies this embodiment.

### (SUL)

The SUL 42 shown in FIG. 8 is a single-layer SUL. The SUL 42 is a layer that is provided to efficiently draw the leakage flux generated from a perpendicular magnetic head when performing magnetic recording on the recording layer 14 into the recording layer 14. That is, by providing the SUL 42, it is possible to increase the strength of the magnetic field from the magnetic head and obtain the magnetic tape MT2 more suitable for high-density recording. Note that the magnetic tape MT3 including the SUL 42 may also be referred to as a “two-layer perpendicular magnetic tape”.

The SUL 42 contains a soft magnetic material in an amorphous state. For example, it can be formed of a CoZrNb alloy that is a Co material, and other materials such as CoZrTa and CoZrTaNb can be adopted. Further, FeCoB, FeCoZr, FeCoTa, or the like, which is an Fe material, may be adopted. The SUL 42 may include an Antiparallel Coupled SUL (APC-SUL) having a structure in which two soft magnetic layers are formed with a thin intervening layer therebetween and the magnetization is actively made antiparallel by utilizing exchange-coupling via the intervening layer.

The magnetic tape MT3 may include an APC-SUL (Antiparallel Coupled SUL) instead of the single-layer SUL 42. The APC-SUL has a structure in which two soft magnetic layers are provided with a thin intervening layer therebetween and the magnetization is actively made antiparallel by utilizing exchange-coupling via the intervening layer.

### 4 Fourth Embodiment

In the fourth embodiment, a cartridge including the magnetic tape MT1 according to the first embodiment will be described.

### [Configuration of Cartridge]

FIG. 9 is an exploded perspective view showing an example of a configuration of a cartridge 110 according to a fourth embodiment. The cartridge 110 is a one-reel type cartridge and includes, inside a cartridge case 112 including a lower shell 112A and an upper shell 112B, one reel 113 on which the magnetic tape MT1 is wound, a reel lock 114 and a reel spring 115 for locking the rotation of the reel 113, a spider 116 for releasing the locked state of the reel 113, a slide door 117 for opening and closing a tape outlet 112C provided in the cartridge case 112 across the lower shell 112A and the upper shell 112B, a door spring 118 that biases the slide door 117 to the closed position of the tape outlet 112C, a write protector 119 for preventing accidental erasure, and a cartridge memory 111. The reel 113 for winding the magnetic tape MT1 has a substantially disk shape with an opening in the center and includes a reel hub 113A and a flange 113B formed of a hard material such as plastic. A leader tape LT is connected to an end portion of the magnetic tape MT1 on the outer periphery side. A leader pin 120 is provided at the tip of the leader tape LT.

The cartridge 110 may be a magnetic tape cartridge conforming to the LTO (Linear Tape-Open) standard or a magnetic tape cartridge conforming to a standard other than the LTO standard.

The cartridge memory 111 is provided in the vicinity of one corner portion of the cartridge 110. When the cartridge 110 is loaded into a recording/reproduction apparatus, the cartridge memory 111 faces the reader/writer of the recording/reproduction apparatus. The cartridge memory 111 communicates with the recording/reproduction apparatus, specifically the reader/writer, using a wireless communication standard conforming to a predetermined standard such as the LTO standard.

### [Configuration of Cartridge Memory]

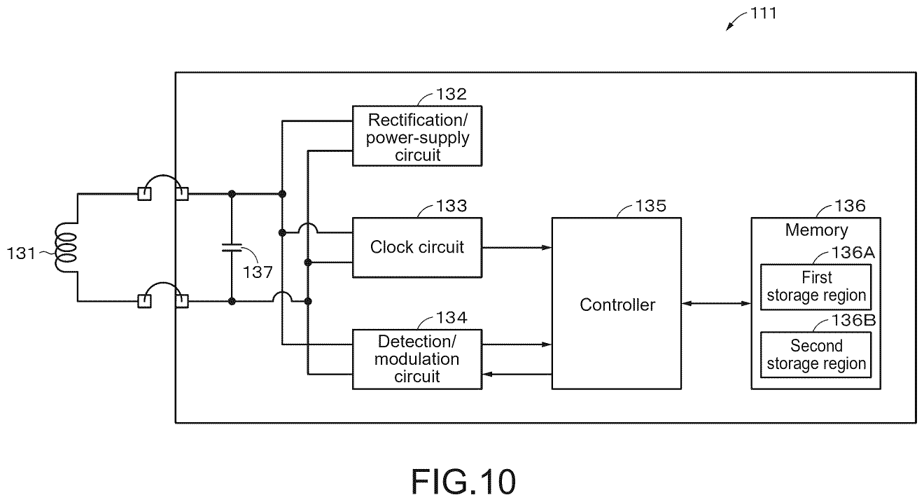

FIG. 10 is a block diagram showing an example of a configuration of the cartridge memory 111. The cartridge memory 111 includes an antenna coil (communication unit) 131 that communicates with a reader/writer using a predetermined communication standard, a rectification/power-supply circuit 132 that generates power from radio waves received by the antenna coil 131 using an induced electromotive force and rectifies the power to generate power supply, a clock circuit 133 that generates a clock from radio wavers received by the antenna coil 131 using an induced electromotive force similarly, a detection/modulation circuit 134 that detects radio waves received by the antenna coil 131 and modulates signals to be transmitted by the antenna coil 131, a controller (control unit) 135 that includes a logic circuit or the like for determining and processing a command and data from a digital signal extracted from the detection/modulation circuit 134, and a memory (storage unit) 136 that stores information. Further, the cartridge memory 111 includes a capacitor 137 connected in parallel to the antenna coil 131, and the antenna coil 131 and the capacitor 137 constitute a resonant circuit.

The memory 136 stores in formation relating to the cartridge 110, and the like. The memory 136 is a non-volatile memory (NVM). The memory capacity of the memory 136 is favorably approximately 32 KB or more.

The memory 136 may have a first storage region 136A and a second storage region 136B. The first storage region 136A corresponds to, for example, the storage region of the cartridge memory in a magnetic tape standard before a predetermined generation (e.g., the LTO standard before LTO8) and is a region for storing information conforming to the magnetic tape standard before the predetermined generation. The information conforming to the magnetic tape standard before the predetermined generation is, for example, manufacturing information (e.g., the unique number of the cartridge 110) or a usage history (e.g., the number of times the tape has been pulled out (Thread Count)).

The second storage region 136B corresponds to the expanded storage region for the storage region of the cartridge memory in the magnetic tape standard before the predetermined generation (e.g., the LTO standard before LTO8). The second storage region 136B is a region for storing additional information. Here, the additional information means, for example, information relating to the cartridge 110, which is not specified in the magnetic tape standard before the predetermined generation (e.g., the LTO standard before LTO8). The additional information includes, for example, at least one type of information selected from the group consisting of tension adjustment information, management ledger data, Index information, and thumbnail information, but is not limited these pieces of data. The tension adjustment information is information for adjusting the tension applied in the longitudinal direction of the magnetic tape MT1. The tension adjustment information includes, for example, at least one type of information selected from the group consisting of information obtained by intermittently measuring the width between servo bands in the longitudinal direction of the magnetic tape MT1, tension information of a drive, and information regarding the temperature and humidity of the drive. These pieces of information are managed in conjunction with information regarding the usage status of the cartridge 110 in some cases. The tension adjustment information is favorably obtained when data is recorded on the magnetic tape MT1 or before data is recorded. The information of the drive means information regarding the tension applied in the longitudinal direction of the magnetic tape MT1.

The management ledger data is data that includes at least one selected from the group consisting of the capacity, creation date, editing date, and storage location of the data file recorded on the magnetic tape MT1. The Index information includes metadata for searching for the content of the data file, or the like. The thumbnail information includes the thumbnail of a moving image or a still image stored in the magnetic tape MT1.

The memory 136 may include a plurality of banks. In this case, some of the plurality of banks may form the first storage region 136A and the remaining banks may form the second storage region 136B.

The antenna coil 131 induces an induced voltage by electromagnetic induction. The controller 135 communicates with a recording/reproduction apparatus in accordance with the predetermined communication standard via the antenna coil 131. Specifically, for example, mutual authentication, transmission/reception of a command, data exchange, or the like is performed.

The controller 135 stores information received from the recording/reproduction apparatus via the antenna coil 131 in the memory 136. For example, tension adjustment information received from the recording/reproduction apparatus via the antenna coil 131 is stored in the second storage region 136B of the memory 136. The controller 135 reads information from the memory 136 in accordance with a request from the recording/reproduction apparatus, and transmits the read information to the recording/reproduction apparatus via the antenna coil 131. For example, in accordance with a request from the recording/reproduction apparatus, tension adjustment information is read from the second storage region 136B of the memory 136, and the read tension adjustment information is transmitted to the recording/reproduction apparatus via the antenna coil 131.

### Modified Example

Although an example in which the cartridge 110 includes the magnetic tape MT1 according to the first embodiment has been described in the fourth embodiment, the cartridge 110 may include the magnetic tape MT2 according to the second embodiment or the magnetic tape MT3 according to the third embodiment.

### 5 Fifth Embodiment

Although the case where the magnetic tape cartridge is the one-reel type cartridge 110 has been described in the above fourth embodiment, the type of cartridge is not limited thereto, and, for example, a two-reel type cartridge may be adopted. In the fifth embodiment, a two-reel type cartridge will be described.

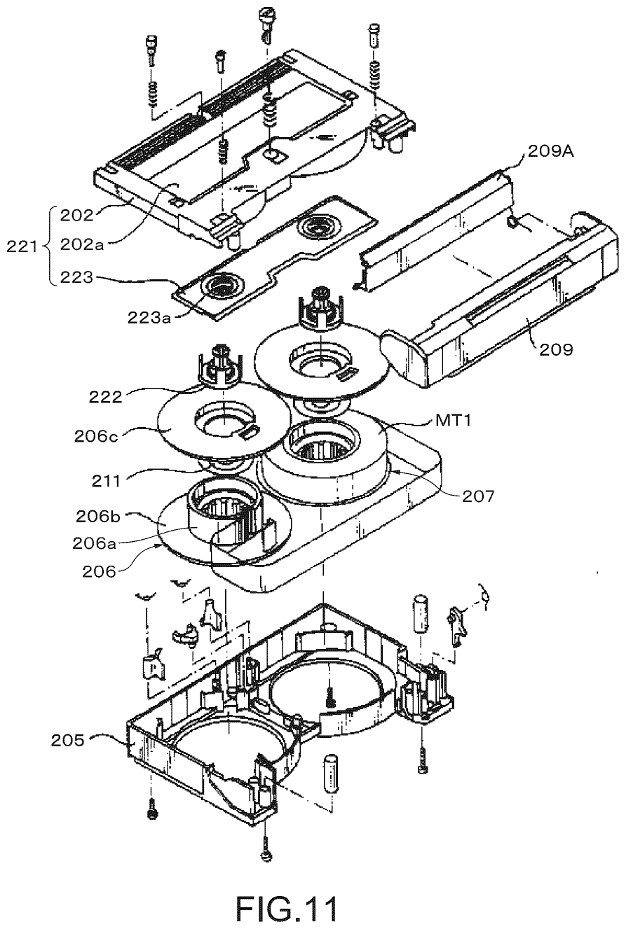

FIG. 11 is an exploded perspective view showing an example of a configuration of a cartridge 221 according to the third embodiment. The cartridge 221 is a two-reel type the cartridge 221. The cartridge 221 includes an upper half 202 formed of a synthetic resin, a transparent window member 223 that is fitted into and fixed to a window portion 202a that is opened on the upper surface of the upper half 202, a reel holder 222 that is fixed to the inside of the upper half 202 and prevents reels 206 and 207 from floating, a lower half 205 corresponding to the upper half 202, the reels 206 and 207 housed in the space formed by combining the upper half 202 and the lower half 205, the magnetic tape MT1 wound on the reels 206 and 207, a front lid 209 that closes a front-side opening formed by combining the upper half 202 and the lower half 205, and a back lid 209A that protects the magnetic tape MT1 exposed in the front-side opening.

The reels 206 and 207 are for winding the magnetic tape MT1. The reel 206 includes a lower flange 206b that includes a cylindrical hub portion 206a in the center around which the magnetic tape MT1 is wound, an upper flange 206c having substantially the same size as the lower flange 206b, and a reel plate 211 sandwiched between the hub portion 206a and the upper flange 206c. The reel 207 has a configuration similar to that of the reel 206.

The window member 223 is provided with mounting holes 223a for mounting the reel holders 222 at positions corresponding to the reels 206 and 207, the reel holders 222 being reel holding means that prevent these reels from floating.

### Modified Example

Although the example in which the cartridge 221 includes the magnetic tape MT1 according to the first embodiment has been described in the fifth embodiment, the cartridge 221 may include the magnetic tape MT2 according to the second embodiment or the magnetic tape MT3 according to the third embodiment.

### EXAMPLES

Although the present disclosure will be specifically described with reference to examples, the present disclosure is not limited to these Examples.

In this Example, the average thickness of each of a base, a first seed layer, a second seed layer, a first underlayer, a second underlayer, a recording layer, a CAP layer, and a protective layer is the value obtained by the measurement method described in the above first embodiment. Further, the content of each atom in the recording layer is also the value obtained by the measurement method described in the above first embodiment.

### Example 1

### (Process of Depositing First Seed Layer)

First, a first seed layer that is formed of (TiCr)₉₈O₂ and has an average thickness of 2.0 nm was deposited on the first main surface of a long polymer film (base) under the following deposition conditions. Note that as the polymer film, an aramid film having a thickness of 4.4 μm was used.
Sputtering method: DC magnetron sputtering method
Target: Ti₅₀Cr₅₀ target
Gas species: Ar
Gas pressure: 0.5 Pa
Input power: 21.5 mW/mm²
Feed speed: 4 m/s

### (Process of Depositing Second Seed Layer)

Next, a second seed layer that is formed of Ni₉₄W₆ and has an average thickness of 10.0 nm was deposited on the first seed layer under the following deposition conditions.
Sputtering method: DC magnetron sputtering method
Target: Ni₉₄W₆ target
Gas species: Ar
Gas pressure: 0.3 Pa
Input power: 47 mW/mm²
Feed speed: 4 m/s

### (Process of Depositing First Underlayer)

Next, a first underlayer that is formed of Ru and has an average thickness of 5.0 nm was deposited on the second seed layer under the following deposition conditions.
Sputtering method: DC magnetron sputtering method
Target: Ru target
Gas species: Ar
Gas pressure: 0.3 Pa
Input power: 24 mW/mm²
Feed speed: 4 m/s

### (Process of Depositing Second Underlayer)

Next, a second underlayer that is formed of Ru and has an average thickness of 17.0 nm was deposited on the first underlayer under the following deposition conditions.
Sputtering method: DC magnetron sputtering method
Target: Ru target
Gas species: Ar
Gas pressure: 13 Pa
Input power: 90 mW/mm²
Feed speed: 4 m/s

### (Process of Depositing Recording Layer)

Next, a recording layer that is formed of (CoPtCr)—(SiO) and has an average thickness of 14.0 nm was deposited on the second underlayer under the following deposition conditions.
Deposition method: DC magnetron sputtering method
Target: (CoCrPt)—(SiO) target
Gas species: Ar
Gas pressure: 6 Pa
Input power: 90 mW/mm²
Feed speed: 4 m/s

However, the composition of the target was adjusted such that the content [at. %] of each of Co, Pt, Cr, Si, and O in the recording layer was the value shown in Table 1.

### (Process of Depositing Protective Layer)

Next, a protective layer that is formed of carbon and has an average thickness of 5.0 nm was deposited on the recording layer under the following deposition conditions.
Deposition method: DC magnetron sputtering method
Target: carbon target
Gas species: Ar
Gas pressure: 0.8 Pa
Input power: 90 mW/mm²×3 cathodes
Feed speed: 9 m/s

### (Process of Depositing Lubricant Layer)

Next, a prepared lubricant paint was applied onto the protective layer to deposit a lubricant layer. Note that the lubricant paint was prepared by mixing 0.11 mass % of perfluoroalkylester carboxylate and 0.06 mass % of a fluoroalkyl dicarboxylic acid derivative in a general-purpose solvent.

### (Process of Depositing Backcoat Layer)

Next, a paint for depositing a back layer was applied onto the second main surface of the polymer film as a base and dried to form a back layer. In more detail, a back layer that includes a non-magnetic powder formed of carbon and calcium carbonate and a polyurethane binder was formed to have an average thickness of 0.3 μm. In this way, a target magnetic tape was obtained.

### Example 2

A magnetic tape was obtained in the same manner as in Example 1 except that the average thickness of the recording layer was changed to 16.0 nm in the process of depositing a recording layer.

### Example 3

A magnetic tape was obtained in the same manner as in Example 1 except that the composition of the target was changed such that the content [at. %] of each of Co, Pt, Cr, Si, and O in the recording layer was the value shown in Table 1 in the process of depositing a recording layer.

### Example 4

A magnetic tape was obtained in the same manner as in Example 3 except that the average thickness of the recording layer was changed to 13.0 nm in the process of depositing a recording layer.

### Example 5

A magnetic tape was obtained in the same manner as in Example 3 except that a CAP layer that was formed of Co₆₅Pt₂₀Cr_{7.5}B_{7.5} and had an average thickness of 2.0 nm was deposited on the recording layer between the process of depositing a recording layer and the process of depositing a protective layer under the following deposition conditions.
Deposition method: DC magnetron sputtering method
Target: Co₆₅Pt₂₀Cr_{7.5}B_{7.5} target
Gas species: Ar
Gas pressure: 1.5 Pa
Input power: 13.5 mW/mm²
Feed speed: 4 m/s

### Example 6

A magnetic tape was obtained in the same manner as in Example 3 except that the average thickness of the CAP layer was changed to 2.5 nm in the process of depositing a CAP layer.

### Example 7

A magnetic tape was obtained in the same manner as in Example 3 except that the average thickness of the CAP layer was changed to 3.0 nm in the process of depositing a CAP layer.

### Example 8

A magnetic tape was obtained in the same manner as in Example 1 except that the composition of the target was changed such that the content [at. %] of each of Co, Pt, Cr, Si, and O in the recording layer was the value shown in Table 1 in the process of depositing a recording layer.

### Example 9

The average thickness of the recording layer was changed to 12.0 nm in the process of depositing a recording layer. Further, a CAP layer that was formed of Co₆₁Pt₁₃Cr₁₉B₇ and had an average thickness of 2.0 nm was deposited on the recording layer using a Co₆₁Pt₁₃Cr₁₉B₇ target between the process of depositing a recording layer and the process of depositing a protective layer. A magnetic tape was obtained in the same manner as in Example 8 except for the above.

### Example 10

A magnetic tape was obtained in the same manner as in Example 9 except that the average thickness of the second underlayer was changed to 14.0 nm in the process of depositing a second underlayer.

### Example 11

A magnetic tape was obtained in the same manner as in Example 9 except that the average thickness of the recording layer was changed to 11.0 nm in the process of depositing a recording layer and the average thickness of the CAP layer was changed to 3.0 nm in the process of depositing a CAP layer.

### Example 12

In the process of depositing a recording layer, a recording layer that was formed of (CoPtCr)—(BO) and had an average thickness of 14.0 nm was deposited on the second underlayer using a (CoPtCr)—(BO) target as a target. However, the composition of the target was adjusted such that the content [at. %] of each of Co, Pt, Cr, B, and O in the recording layer was the value shown in Table 1. Further, a CAP layer that was formed of Co₆₀Pt₂₀Cr₁₀B₁₀ and had an average thickness of 5.0 nm was deposited on the recording layer using a Co₆₀Pt₂₀Cr₁₀B₁₀ target between the process of depositing a recording layer and the process of depositing a protective layer. A magnetic tape was obtained in the same manner as in Example 1 except for the above.

### Example 13

The composition of the target was changed such that the content [at. %] of each of Co, Pt, Cr, B, and O in the recording layer was the value shown in Table 1 in the process of depositing a recording layer. Further, the average thickness of the recording layer was changed to 16.0 nm in the process of depositing a recording layer. A magnetic tape was obtained in the same manner as in Example 12 except for the above.

### Comparative Example 1

A magnetic tape was obtained in the same manner as in Example 8 except that the average thickness of the recording layer was changed to 10.0 nm in the process of depositing a recording layer.

### Comparative Example 2

A magnetic tape was obtained in the same manner as in Example 8 except that the average thickness of the recording layer was changed to 9.0 nm in the process of depositing a recording layer.

### Comparative Example 3

A magnetic tape was obtained in the same manner as in Example 12 except that the average thicknesses of the first underlayer and the second underlayer were respectively changed to 3.0 nm and 10.0 nm in the process of depositing a first underlayer and the process of depositing a second underlayer and the process of forming a CAP layer was omitted.

### Comparative Example 4

A magnetic tape was obtained in the same manner as in Comparative Example 3 except that the average thickness of the recording layer was changed to 15.0 nm in the process of depositing a recording layer.

### Comparative Example 5

A magnetic tape was obtained in the same manner as in Comparative Example 3 except that the average thickness of the recording layer was changed to 16.0 nm in the process of depositing a recording layer.

### Comparative Example 6

In the process of depositing a recording layer, a recording layer that was formed of (CoPtCr)—(BO) and had an average thickness of 14.0 n was deposited on the second underlayer using a (CoPtCr)—(BO) target as a target. However, the composition of the target was adjusted such that the content [at. %] of each of Co, Pt, Cr, B, and O in the recording layer was the value shown in Table 1. Further, a CAP layer that was formed of Co₆₁Pt₁₃Cr₁₉B₇ and had an average thickness of 5.0 nm was deposited on the recording layer using a Co₆₁Pt₁₃Cr₁₉B₇ target between the process of depositing a recording layer and the process of depositing a protective layer. A magnetic tape was obtained in the same manner as in Example 1 except for the above. Comparative Example 7

A magnetic tape was obtained in the same manner as in Comparative Example 6 except that the average thickness of the recording layer was changed to 16.0 nm in the process of depositing a recording layer.

### Comparative Example 8

A magnetic tape was obtained in the same manner as in Comparative Example 6 except that the average thickness of the recording layer was changed to 9.0 nm in the process of depositing a recording layer and the process of forming a CAP layer was omitted.

### Comparative Example 9

A magnetic tape was obtained in the same manner as in Comparative Example 8 except that the average thickness of the recording layer was changed to 8.0 nm in the process of depositing a recording layer.

### Comparative Example 10

In the process of depositing a first underlayer, a first underlayer that was formed of CoCr and had an average thickness of 45.0 nm was deposited on the second seed layer using a CoCr target. Further, in the process of depositing a second underlayer, a second underlayer that was formed of CoCr—TiO₂ and had an average thickness of 5.0 nm was deposited on the first underlayer using a CoCr—TiO₂ target. A magnetic tape was obtained in the same manner as in Example 1 except for the above.

### Comparative Example 11

A magnetic tape was obtained in the same manner as in Comparative Example 10 except that a recording layer that was formed of (CoCrPt)—(BO) and had an average thickness of 14.0 nm was deposited on the second underlayer in the process of depositing a recording layer, similarly to the process of depositing a recording layer in Comparative Example 6.

### Comparative Example 12

A magnetic tape was obtained in the same manner as in Comparative Example 11 except that the average thickness of the first underlayer was changed to 25.0 nm in the process of depositing a first underlayer and the average thickness of the second underlayer was changed to 25.0 nm in the process of depositing a second underlayer.

### [Evaluation]

The magnetic tapes obtained as described above were evaluated as follows.

$$( {( Mrt )}^{0.5} \times f ( H s ) )$$

The parameter (Mrt)^{0.5}×f(Hs) of the magnetic tape was obtained by the measurement method for the parameter (Mrt)^{0.5}×f(Hs) described in the first embodiment. The results are shown in Table 1.

### (Nucleation Magnetic Field Hn)

The nucleation magnetic field Hn of the magnetic tape was obtained by the measurement method for the nucleation magnetic field Hn described in the first embodiment. The results are shown in Table 1.

### (Reproduction Output)

The reproduction output was obtained as follows. First, a reproduction signal of the magnetic tape was obtained using a loop tester (manufactured by Microphysics). The conditions for acquiring the reproduction signal are shown below.
Writer: Ring Type head
Reader: TMR head
Reader width: 800 nm
Speed: 1.5 m/s
Signal: single recording frequency (400 kfci)
Recording current: optimum recording current

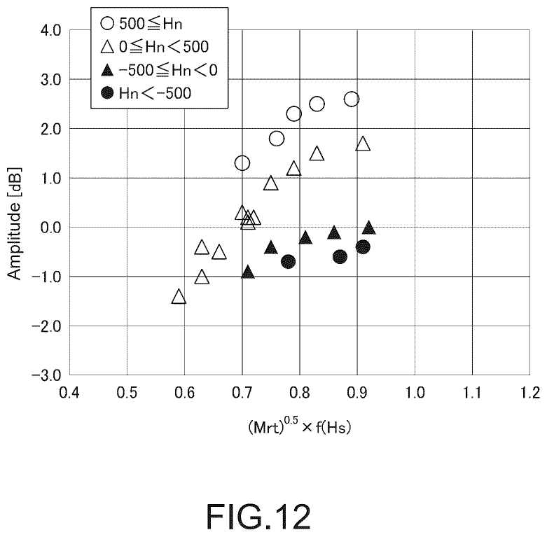

The recording wavelength was set to 400 kFCI (kilo Flux Changes per Inch), and a voltage obtained from the value obtained by integrating the spectrum in near the recording wavelength in the band from 377.5 kFCI to 422.5 kFCI was used as a reproduction output. Next, the obtained reproduction output was converted into a relative value (dB) with reference to the reproduction output in Comparative Example 7 as a reference medium. The results are shown in Table 1. First, the relationship between the parameter (Mrt)^{0.5}×f(Hs) and the amplitude of the reproduction signal is shown in FIG. 12.

TABLE 1

| | | | | | | | | | | | Underlayer | |
|---|---|---|---|---|---|---|---|---|---|---|---|---|
| | | | Recording layer | | | | | | | | Second | |
| | CAP layer | | | | | | | | | | under layer | |
| | | Average | Composition | | | | | | | Average | | Average |
| | | thickness | Co | Pt | Cr | Si | B | O | Total | thickness | | thickness |
| | Material | [nm] | [at %] | [at %] | [at %] | [at %] | [at %] | [at %] | [at %] | [nm] | Material | [nm] |
| Example 1 | — | — | 51.1 | 10.2 | 11.7 | 9.0 | 0.0 | 18.0 | 100.0 | 14.0 | Ru | 17.0 |
| Example 2 | — | — | 51.1 | 10.2 | 11.7 | 9.0 | 0.0 | 18.0 | 100.0 | 16.0 | Ru | 17.0 |
| Example 3 | — | — | 47.2 | 15.2 | 13.7 | 6.6 | 0.0 | 17.2 | 100.0 | 14.0 | Ru | 17.0 |
| Example 4 | — | — | 47.2 | 15.2 | 13.7 | 6.6 | 0.0 | 17.2 | 100.0 | 13.0 | Ru | 17.0 |
| Example 5 | Co [symbol] Pt₂₀Cr_{7.5}B_{7.5} | 2.0 | 47.2 | 15.2 | 13.7 | 6.6 | 0.0 | 17.2 | 100.0 | 14.0 | Ru | 17.0 |
| Example 6 | Co [symbol] Pt₂₀Cr_{7.5}B₇₅ | 2.5 | 47.2 | 15.2 | 13.7 | 6.6 | 0.0 | 17.2 | 100.0 | 14.0 | Ru | 17.0 |
| Example 7 | Co [symbol] Pt₂₀Cr_{7.5}B₇₅ | 3.0 | 47.2 | 15.2 | 13.7 | 6.6 | 0.0 | 17.2 | 100.0 | 14.0 | Ru | 17.0 |
| Example 8 | — | — | 45.4 | 14.7 | 13.2 | 6.4 | 0.0 | 20.4 | 100.0 | 14.0 | Ru | 17.0 |
| Example 9 | Co₆₁Pt₁₃Cr₁₃B₇ | 2.0 | 45.4 | 14.7 | 13.2 | 6.4 | 0.0 | 20.4 | 100.0 | 12.0 | Ru | 17.0 |
| Example 10 | Co₆₁Pt₁₃Cr₁₃B₇ | 2.0 | 45.4 | 14.7 | 13.2 | 6.4 | 0.0 | 20.4 | 100.0 | 12.0 | Ru | 14.0 |
| Example 11 | Co₆₁Pt₁₃Cr₁₃B₇ | 3.0 | 45.4 | 14.7 | 13.2 | 6.4 | 0.0 | 20.4 | 100.0 | 11.0 | Ru | 17.0 |
| Example 12 | Co₆₀Pt₂ [symbol] Cr₁₆B₁₀ | 5.0 | 51.3 | 12.8 | 7.1 | 0.0 | 11.5 | 17.2 | 100.0 | 14.0 | Ru | 17.0 |
| Example 13 | Co₆₀Pt₂ [symbol] Cr₁₆B₁₀ | 5.0 | 52.7 | 11.4 | 7.1 | 0.0 | 11.5 | 17.2 | 100.0 | 16.0 | Ru | 17.0 |
| Comparative | — | — | 45.4 | 14.7 | 13.2 | 6.4 | 0.0 | 20.4 | 100.0 | 10.0 | Ru | 17.0 |
| Example 1 | | | | | | | | | | | | |
| Comparative | — | — | 45.4 | 14.7 | 13.2 | 6.4 | 0.0 | 20.4 | 100.0 | 9.0 | Ru | 17.0 |
| Example 2 | | | | | | | | | | | | |
| Comparative | — | — | 51.3 | 12.8 | 7.1 | 0.0 | 11.5 | 17.2 | 100.0 | 14.0 | Ru | 10.0 |
| Example 3 | | | | | | | | | | | | |
| Comparative | — | — | 51.3 | 12.8 | 7.1 | 0.0 | 11.5 | 17.2 | 100.0 | 15.0 | Ru | 10.0 |
| Example 4 | | | | | | | | | | | | |
| Comparative | — | — | 51.3 | 12.8 | 7.1 | 0.0 | 11.5 | 17.2 | 100.0 | 16.0 | Ru | 10.0 |
| Example 5 | | | | | | | | | | | | |
| Comparative | Co₆₁Pt₁₃Cr₁₃B₇ | 5.0 | 49.9 | 12.5 | 8.9 | 0.0 | 11.5 | 17.2 | 100.0 | 14.0 | Ru | 17.0 |
| Example 6 | | | | | | | | | | | | |
| Comparative | Co₆₁Pt₁₃Cr₁₃B₇ | 5.0 | 49.9 | 12.5 | 8.9 | 0.0 | 11.5 | 17.2 | 100.0 | 1 [symbol] .0 | Ru | 17.0 |
| Example 7 | | | | | | | | | | | | |
| Comparative | — | — | 49.9 | 12.5 | 8.9 | 0.0 | 11.5 | 17.2 | 100.0 | 9.0 | Ru | 17.0 |
| Example 8 | | | | | | | | | | | | |
| Comparative | — | — | 49.9 | 12.5 | 8.9 | 0.0 | 11.5 | 17.2 | 100.0 | 8.0 | Ru | 17.0 |
| Example 9 | | | | | | | | | | | | |
| Comparative | — | — | 51.1 | 10.2 | 11.7 | 9.0 | 0.0 | 18.0 | 100.0 | 14.0 | CoCr—TiO₂ | 5.0 |
| Example 10 | | | | | | | | | | | | |
| Comparative | — | — | 4 [symbol] . [symbol] | 12.5 | 8. [symbol] | 0.0 | 11.5 | 17.2 | 100.0 | 14.0 | CoCr—TiO₂ | 5.0 |
| Example 11 | | | | | | | | | | | | |
| Comparative | — | — | 49.9 | 12.5 | 8.9 | 0.0 | 11.5 | 17.2 | 100.0 | 14.0 | CoCr—TiO₂ | 25.0 |
| Example 12 | | | | | | | | | | | | |

| | Underlayer | | Seed layer | | | | | | | | | |
|---|---|---|---|---|---|---|---|---|---|---|---|---|
| | First | | Second | | First | | | | | | | |
| | under layer | | seed layer | | seed layer | | | | | | | |
| | | Average | | Average | | Average | | | | | | |
| | | thickness | | thickness | | thickness | (Mrt)^{0.5} | Hs | | (Mrt)^{0.5} × | Hn | Amplitude |
| | Material | [nm] | Material | [nm] | Material | [nm] | [memu/cm²] | [Oe] | f(Hs) | f(Hs) | [Oe] | [dB [symbol] |
| Example 1 | Ru | 5.0 | Ni [symbol] W [symbol] | 10.0 | (TiCr)₉₈O₂ | 2.0 | 0.75 | 7500 | 1.00 | 0.75 | 30 | 0.9 |
| Example 2 | Ru | 5.0 | Ni [symbol] W₆ | 10.0 | (TiCr)₉₈O₂ | 2.0 | 0.80 | 8600 | 0.99 | 0.79 | 200 | 1.2 |
| Example 3 | Ru | 5.0 | Ni [symbol] W₆ | 10.0 | (TiCr)₉₈O₂ | 2.0 | 0.76 | 8400 | 1.00 | 0.76 | 520 | 1.3 |
| Example 4 | Ru | 5.0 | Ni [symbol] W₆ | 10.0 | (TiCr)₉₈O₂ | 2.0 | 0.72 | 8700 | 0.98 | 0.70 | 500 | 1.3 |
| Example 5 | Ru | 5.0 | Ni [symbol] W₆ | 10.0 | (TiCr)₉₈O₂ | 2.0 | 0.79 | 8400 | 1.00 | 0.79 | 520 | 2.3 |
| Example 6 | Ru | 5.0 | Ni [symbol] W₆ | 10.0 | (TiCr)₉₈O₂ | 2.0 | 0.83 | 8500 | 1.00 | 0.83 | 550 | 2.5 |
| Example 7 | Ru | 5.0 | Ni [symbol] W₆ | 10.0 | (TiCr)₉₈O₂ | 2.0 | 0.93 | 8900 | 0.9 [symbol] | 0.89 | 550 | 2.6 |
| Example 8 | Ru | 5.0 | Ni [symbol] W₆ | 10.0 | (TiCr)₉₈O₂ | 2.0 | 0.79 | 9500 | 0.90 | 0.71 | 0 | 0.1 |
| Example 9 | Ru | 5.0 | Ni [symbol] W₆ | 10.0 | (TiCr)₉₈O₂ | 2.0 | 0.75 | 9000 | 0.94 | 0.71 | 0 | 0.2 |
| Example 10 | Ru | 5.0 | Ni [symbol] W₆ | 10.0 | (TiCr)₉₈O₂ | 2.0 | 0.70 | 8000 | 1.00 | 0.70 | 100 | 0.3 |
| Example 11 | Ru | 5.0 | Ni [symbol] W₆ | 10.0 | (TiCr)₉₈O₂ | 2.0 | 0.72 | 8500 | 1.00 | 0.72 | 100 | 0.2 |
| Example 12 | Ru | 5.0 | Ni [symbol] W₆ | 10.0 | (TiCr)₉₈O₂ | 2.0 | 0.83 | 8000 | 1.00 | 0.83 | 300 | 1.5 |
| Example 13 | Ru | 5.0 | Ni [symbol] W₆ | 10.0 | (TiCr)₉₈O₂ | 2.0 | 0.96 | 9000 | 0.94 | 0.91 | 400 | 1.7 |
| Comparative | Ru | 5.0 | Ni [symbol] W₆ | 10.0 | (TiCr)₉₈O₂ | 2.0 | 0.70 | 9000 | 0.94 | 0.66 | 10 | −0.5 |
| Example 1 | | | | | | | | | | | | |
| Comparative | Ru | 5.0 | Ni [symbol] W₆ | 10.0 | (TiCr)₉₈O₂ | 2.0 | 0.70 | 9500 | 0.90 | 0.63 | 30 | −1.0 |
| Example 2 | | | | | | | | | | | | |
| Comparative | Ru | 3.0 | Ni [symbol] W₆ | 10.0 | (TiCr)₉₈O₂ | 2.0 | 0.84 | 9200 | 0.9 [symbol] | 0.78 | −650 | −0.7 |
| Example 3 | | | | | | | | | | | | |
| Comparative | Ru | 3.0 | Ni [symbol] W₆ | 10.0 | (TiCr)₉₈O₂ | 2.0 | 0.97 | 9500 | 0.90 | 0.87 | −600 | −0.6 |
| Example 4 | | | | | | | | | | | | |
| Comparative | Ru | 3.0 | Ni [symbol] W₆ | 10.0 | (TiCr)₉₈O₂ | 2.0 | 1.02 | 9500 | 0.90 | 0.91 | −550 | −0.4 |
| Example 5 | | | | | | | | | | | | |
| Comparative | Ru | 5.0 | Ni [symbol] W₆ | 10.0 | (TiCr)₉₈O₂ | 2.0 | 0.92 | 9100 | 0.93 | 0.8 [symbol] | −200 | −0.1 |
| Example 6 | | | | | | | | | | | | |
| Comparative | Ru | 5.0 | Ni [symbol] W₆ | 10.0 | (TiCr)₉₈O₂ | 2.0 | 0.97 | 9000 | 0.94 | 0. [symbol] 2 | −200 | 0.0 |
| Example 7 | | | | | | | | | | | | |
| Comparative | Ru | 5.0 | Ni [symbol] W₆ | 10.0 | (TiCr)₉₈O₂ | 2.0 | 0.63 | 8500 | 1.00 | 0.63 | 10 | −0.4 |
| Example 8 | | | | | | | | | | | | |
| Comparative | Ru | 5.0 | Ni [symbol] W₆ | 10.0 | (TiCr)₉₈O₂ | 2.0 | 0.59 | 8300 | 1.00 | 0.59 | 0 | −1.4 |
| Example 9 | | | | | | | | | | | | |
| Comparative | CoCr | 45.0 | Ni [symbol] W₆ | 10.0 | (TiCr)₉₈O₂ | 2.0 | 0.73 | 8700 | 0.98 | 0.71 | −500 | −0.9 |
| Example 10 | | | | | | | | | | | | |
| Comparative | CoCr | 45.0 | Ni [symbol] W₆ | 10.0 | (TiCr)₉ [symbol] O₂ | 2.0 | 0.77 | 8700 | 0.98 | 0.75 | −500 | −0.4 |
| Example 11 | | | | | | | | | | | | |
| Comparative | CoCr | 25.0 | Ni [symbol] W₆ | 10.0 | (TiCr)₉₈O₂ | 2.0 | 0.86 | 9000 | 0.94 | 0.81 | −300 | −0.2 |
| Example 12 | | | | | | | | | | | | |

[symbol]

indicates data missing or illegible when filed

The following can be seen from the results of the above evaluation.

In the magnetic tapes (Examples 1 to 13) in which the nucleation magnetic field Hn of the magnetic tape satisfies the following relationship: Hn≥0 [Oe] and the parameter (Mrt)^{0.5}×f(Hs) satisfies the following relationship: (Mrt)^{0.5}×f(Hs)≥0.70, the reproduction output (amplitude) of the magnetic tape can be increased.

In the magnetic tapes (Comparative Examples 1, 2, 8, and 9) in which the nucleation magnetic field Hn of the magnetic tape satisfies the following relationship: Hn≥0 [Oe] but the parameter (Mrt)^{0.5}×f(Hs) does not satisfy the following relationship: (Mrt)^{0.5}×f(Hs)≥0.70, the reproduction output (amplitude) of the magnetic tape is reduced.

In the magnetic tapes (Comparative Examples 3 to 7 and 10 to 12) in which the parameter (Mrt)^{0.5}×f(Hs) satisfies the following relationship: (Mrt)^{0.5}×f(Hs)≥0.70 but the nucleation magnetic field Hn of the magnetic tape satisfies the following relationship: Hn<0 [Oe], the reproduction output (amplitude) of the magnetic tape is reduced.

Although embodiments and modified examples of the present disclosure have been specifically described above, the present disclosure is not limited to the above embodiments and modified examples, and various modifications can be made on the basis of the technical idea of the present disclosure. For example, the configurations, methods, processes, shapes, materials, numerical values, and the like mentioned in the above embodiments and modified examples are merely examples, and configurations, methods, processes, shapes, materials, numerical values, and the like different from these may be used as necessary. The configurations, methods, processes, shapes, materials, numerical values, and the like of the above embodiments and modified examples can be combined with each other without departing from the essence of the present disclosure.

The chemical formulae of compounds and the like exemplified in the above embodiments and modified examples are representative ones, and they are not limited to the stated valances and the like as long as they are general names of the same compounds. In the numerical ranges described in stages in the above embodiments and modified examples, the upper limit value or the lower limit value in the numerical range of one stage may be replaced with the upper limit value or the lower limit value in the numerical range of another stage. The materials exemplified in the above embodiments and modified examples can be used alone, or two or more of them can be used in combination, unless otherwise specified.

Further, the present disclosure may also take the following configurations.
(1) A tape-shaped magnetic recording medium, including:
   a recording layer,
   a nucleation magnetic field Hn of the magnetic recording medium satisfying a relationship of Hn≥0 (Oe),
   the magnetic recording medium satisfying a relationship of the following formula (1).

$${( Mrt )}^{0.5} \times f ( Hs ) \geq 0.7 \qquad ( 1 )$$

(in which, in the formula (1), Mrt represents a product of a residual magnetization amount Mr of the magnetic recording medium and a thickness t of the recording layer. Hs represents a saturation magnetic field of the magnetic recording medium. In a case where Hs≤8500 (Oe), f(Hs)=1.00, and in a case where Hs>8500 (Oe), f(Hs)=1/(1+(Hs−8500)/8500).)
(2) The magnetic recording medium according to (1), in which
   the nucleation magnetic field Hn satisfies a relationship of Hn≥200 (Oe).
(3) The magnetic recording medium according to (1) or (2), in which
   the recording layer satisfies a relationship of the following formula (1A).

$${( Mrt )}^{0.5} \times f ( Hs ) \geq 0.8 \qquad ( 1 A )$$

(4) The magnetic recording medium according to any one of (1) to (3), in which
   the recording layer contains Co, Pt, and Cr.
(5) The magnetic recording medium according to any one of (1) to (3), in which
   the recording layer includes
      crystal grains containing Co, Pt, and Cr, and
      grain boundaries containing at least one selected from the group consisting of Si, Cr, Co, Cu, Al, Ti, Ta, Zr, Ce, Y, B, and Hf, and O (oxygen).
(6) The magnetic recording medium according to any one of (1) to (5), further including:
   a base;
   a seed layer; and
   an underlayer, in this order,
   the recording layer being provided on the underlayer.
(7) The magnetic recording medium according to (6), in which
   the underlayer contains Ru.
(8) The magnetic recording medium according to (6) or (7), in which
   the seed layer includes a first seed layer and a second seed layer in this order.
(9) The magnetic recording medium according to (8), in which
   the first seed layer contains Ti, Cr, and O (oxygen), and
   the second seed layer contains Ni and W.
(10) The magnetic recording medium according to any one of (1) to (9), further including
   a CAP layer,
   the CAP layer being provided on the recording layer.
(11) The magnetic recording medium according to (10), in which
   the CAP layer contains Co, Cr, Pt, and B.
(12) The magnetic recording medium according to any one of (1) to (11), in which
   an average thickness of the recording layer is 10.0 nm or more and 20.0 nm or less.
(13) The magnetic recording medium according to any one of (1) to (12), which is configured to be capable of recording a signal by a ring-type recording head.
(14) A tape-shaped magnetic recording medium, including:
   a recording layer,
   a nucleation magnetic field Hn of the magnetic recording medium satisfying a relationship of Hn≥0 (Oe),
   the magnetic recording medium satisfying a relationship of the following formula (1).

$${( Mrt )}^{0.5} \times f ( Hs ) \geq 0.7 \qquad ( 1 )$$

(in which, in the formula (1), Mrt represents a product of a residual magnetization amount Mr of the magnetic recording medium and a thickness t of the recording layer. Hs represents a saturation magnetic field of the magnetic recording medium. In a case where Hs≤4300 Bs (Oe), f(Hs)=1.00, and in a case where Hs>4300 Bs (Oe), f(Hs)=1/(1+(Hs−4300 Bs)/4300 Bs). Bs represents a saturation magnetic flux density of a core of a recording head used for recording on the magnetic recording medium, and a unit of Bs is tesla (T).)
(15) A cartridge, including:
   the magnetic recording medium according to any one of (1) to (14).

### REFERENCE SIGNS LIST

11 base
12 seed layer
12A first seed layer
12B second seed layer
13 underlayer
13A first underlayer
13B second underlayer
14 recording layer
15 CAP layer
16 protective layer
17 lubricant layer
18 back layer
20 sputtering apparatus
21 deposition chamber
22 drum
23a to 23f cathode
24 supply reel
25 take-up reel
26 exhaust port
27a to 27c, 28a to 28c guide roll
31 core
32 coil
41 intermediate layer
42 soft magnetic underlayer
30 recording head
31 core
31S surface
32 coil
33 column
DM recording magnetization
MT1, MT2, MT3 magnetic tape
110, 221 cartridge
111 cartridge memory
131 antenna coil
132 rectification/power-supply circuit
133 clock circuit
134 detection/modulation circuit
135 controller
136 memory
136A first storage region
136B second storage region

1. A tape-shaped magnetic recording medium, comprising:
a recording layer,
a nucleation magnetic field Hn of the magnetic recording medium satisfying a relationship of Hn≥0 [Oe],
the magnetic recording medium satisfying a relationship of the following formula (1).
$${( Mrt )}^{0.5} \times f ( Hs ) \geq 0.7 \qquad ( 1 )$$
(wherein, in the formula (1), Mrt represents a product of a residual magnetization amount Mr of the magnetic recording medium and a thickness t of the recording layer. Hs represents a saturation magnetic field of the magnetic recording medium. In a case where Hs≤8500 [Oe], f(Hs)=1.00, and in a case where Hs>8500 [Oe], f(Hs)=1/(1+(Hs−8500)/8500).)

2. The magnetic recording medium according to claim 1, wherein
the nucleation magnetic field Hn satisfies a relationship of Hn≥200 [Oe].

3. The magnetic recording medium according to claim 1, wherein
the recording layer satisfies a relationship of the following formula (1A).
$${( Mrt )}^{0.5} \times f ( Hs ) \geq 0.8 \qquad ( 1 A )$$

4. The magnetic recording medium according to claim 1, wherein
the recording layer contains Co, Pt, and Cr.

5. The magnetic recording medium according to claim 1, wherein
the recording layer includes
crystal grains containing Co, Pt, and Cr, and
grain boundaries containing at least one selected from the group consisting of Si, Cr, Co, Cu, Al, Ti, Ta, Zr, Ce, Y, B, and Hf, and O (oxygen).

6. The magnetic recording medium according to claim 1, further comprising:
a base;
a seed layer; and
an underlayer, in this order,
the recording layer being provided on the underlayer.

7. The magnetic recording medium according to claim 6, wherein
the underlayer contains Ru.

8. The magnetic recording medium according to claim 6, wherein
the seed layer includes a first seed layer and a second seed layer in this order.

9. The magnetic recording medium according to claim 8, wherein
the first seed layer contains Ti, Cr, and O (oxygen), and
the second seed layer contains Ni and W.

10. The magnetic recording medium according to claim 1, further comprising
a CAP layer,
the CAP layer being provided on the recording layer.

11. The magnetic recording medium according to claim 10, wherein
the CAP layer contains Co, Cr, Pt, and B.

12. The magnetic recording medium according to claim 1, wherein
an average thickness of the recording layer is 10.0 nm or more and 20.0 nm or less.

13. The magnetic recording medium according to claim 1, which is configured to be capable of recording a signal by a ring-type recording head.

14. A tape-shaped magnetic recording medium, comprising:
a recording layer,
a nucleation magnetic field Hn of the magnetic recording medium satisfying a relationship of Hn≥0 [Oe],
the magnetic recording medium satisfying a relationship of the following formula (1).
$${( Mrt )}^{0.5} \times f ( Hs ) \geq 0.7 \qquad ( 1 )$$
(wherein, in the formula (1), Mrt represents a product of a residual magnetization amount Mr of the magnetic recording medium and a thickness t of the recording layer. Hs represents a saturation magnetic field of the magnetic recording medium. In a case where Hs≤4300 Bs [Oe], f(Hs)=1.00, and in a case where Hs>4300 Bs [Oe], f(Hs)=1/(1+(Hs−4300 Bs)/4300 Bs). Bs represents a saturation magnetic flux density of a core of a recording head used for recording on the magnetic recording medium, and a unit of Bs is tesla (T).)

15. A cartridge, comprising:
the magnetic recording medium according to claim 1.
